(19) United States
(12) Patent Application Publication
(10) Pub. No.: US 2003/0016250 A1
(43) Pub. Date: Jan. 23, 2003

(54) Computer user interface for perception-based information retrieval

(76) Inventors: Edward Y. Chang, Santa Barbara, CA (US); Kwang-Ting Cheng, Santa Barbara, CA (US); Wei-Cheng Lai, Santa Barbara, CA (US)

Correspondence Address: Stephen C. Durant, Morrison & Foerster LLP, 425 Market Street, San Francisco, CA, 94105, US

(21) Appl. No.: 10/155,837

(22) Filed: May 22, 2002

Related U.S. Application Data
(63) Continuation-in-part of application No. 10/116,383, filed on Apr. 2, 2002.
Application No. 10/116,383 is a continuation-in-part of application No. 10/032,319, filed on Dec. 21, 2001.
(60) Provisional application No. 60/292,820, filed on May 22, 2001.
(60) Provisional application No. 60/281,053, filed on Apr. 2, 2001.

(51) Int. Cl. G09G 5/00

(52) U.S. Cl. 345/810

(57) ABSTRACT

A computer user interface screen comprising:

a set of multiple possible sample representations of a user query concept in which individual samples of the set of query samples are characterized by a maximum uncertainty as to whether a given user would consider a given individual sample representation to be relevant to that given user's query concept based upon that given user's prior indications of relevance of prior sample representations to that given user's query concept.

### CROSS-REFERENCE TO RELATED APPLICATIONS

This application is a continuation-in-part of Ser. No. 10/116,383 filed Apr. 2, 2002, which is a continuation-in-part of Ser. No. 10/032,319, filed Dec. 21, 2001. This application claims the benefit of the filing date of commonly owned provisional patent application Ser. No. 60/292,820, filed May 22, 2001; and also claims the benefit of the filing date of commonly assigned provisional patent application, Ser. No. 60/281,053, filed Apr. 2, 2001.

### BACKGROUND OF THE INVENTION

1. Field of the Invention

The invention relates in general to information retrieval and more particularly to query-based information retrieval.

2. Description of the Related Art

A query-concept learning approach can be characterized by the following example: Suppose one is asked, “Are the paintings of Leonardo da Vinci more like those of Peter Paul Rubens or those of Raphael?” One is likely to respond with: “What is the basis for the comparison?” Indeed, without knowing the criteria (i.e., the query concept) by which the comparison is to be made, a database system cannot effectively conduct a search. In short, a query concept is that which the user has in mind as he or she conducts a search. In other words, it is that which the user has in mind that serves as his or her criteria for deciding whether or not a particular object is what the user seeks.

For many search tasks, however, a query concept is difficult to articulate, and articulation can be subjective. For instance, in a multimedia search, it is difficult to describe a desired image using low-level features such as color, shape, and texture (these are widely used features for representing images. Different users may use different combinations of these features to depict the same image. In addition, most users (e.g., Internet users) are not trained to specify simple query criteria using SQL, for instance. In order to take individuals' subjectivity into consideration and to make information access easier, it is both necessary and desirable to build intelligent search engines that can discover (i.e., that can learn) individuals' query concepts quickly and accurately.

Moreover, the World-Wide Web and databases move rapidly from text-based towards multimedia content, and requires more personalized access, current user interface schemes have become increasingly inadequate. Thus, there has been a need for a perception-based user interface which can be used as a front-end to systems that learn a users' subjective query concepts quickly through an intelligent sampling process. The present invention meets this need.

### DETAILED DESCRIPTION OF THE PREFERRED EMBODIMENT

The present invention provides a novel computer user interface that can be used as the ‘front-end’ of a perception based information retrieval system. The following description is presented to enable any person skilled in the art to make and use the invention. The embodiments of the invention are described in the context of particular applications and their requirements. These descriptions of specific applications are provided only as examples. Various modifications to the preferred embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles and features disclosed herein.

### EXAMPLES

1. An Initial Example

In this section a user interface embodiment of the invention is described through a series of examples of screen displays and user interactions with such screen displays. The user interface embodiment disclosed herein is produced in response to computer software processes that function to control the presentation of the screen displays and user interaction with the screen displays. Thus, the examples herein not only serve to disclose a novel user interface, but also serve to disclose novel computer software processes encoded in computer readable media used to produce the novel user interface. Moreover, the following examples also serve to disclose novel interactions between a user and a user interface system.

In this first example, we compare a keyword-based image retrieval system with our novel perception-based image retrieval system. We used the Yahoo! Picture Gallery (i.e., http://gallery.yahoo.com) as a test site for keyword-based image retrieval. Suppose a user wants to retrieve images related to “bird of paradise.” Given the keywords “bird of paradise” at the test site, the gallery engine retrieves five images of this flower.

However, there are more than five images relevant to “bird of paradise” in the Yahoo image database. Our system can retrieve more of these relevant images. First, we query Yahoo's keyword-based search engine using “bird” and “flowers” and store the returned images (both birds and flowers) in a local database. Second, we apply our perception-based search engine to the local database. The learning steps for grasping the concept “bird of paradise” involve three screens that are illustrated in the following three figures.

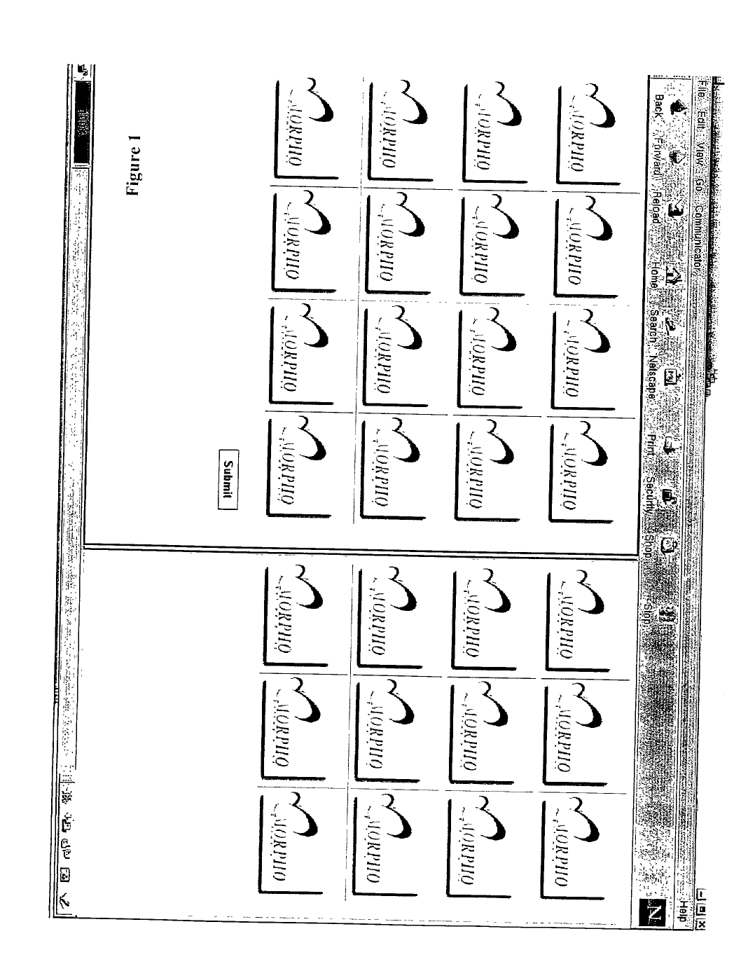

Screen 1. Sampling and relevance feedback starts. The screen is split into two frames horizontally. On the left-hand side of the screen is the learner frame; on the right-hand side is the similarity search frame. Through the learner frame, the system learns what the user wants via an active learning process. The similarity search frame displays images that match the user's query concept. The system presents a set of multiple possible sample representatives of a user query concept in the learner frame, and the user marks sample representations (i.e., images) that are relevant to his or her query concept by clicking on the relevant images. As shown in FIG. 1, one image (the last image in the first row) is selected as relevant, and the rest of the unmarked images are considered irrelevant. The user indicates the end of his or her selection by clicking on the submit button in the learner screen. This action brings up the next screen. Thus clicking on one or more images and then clicking on the submit button serves as a mechanism whereby the user interface receives user input.

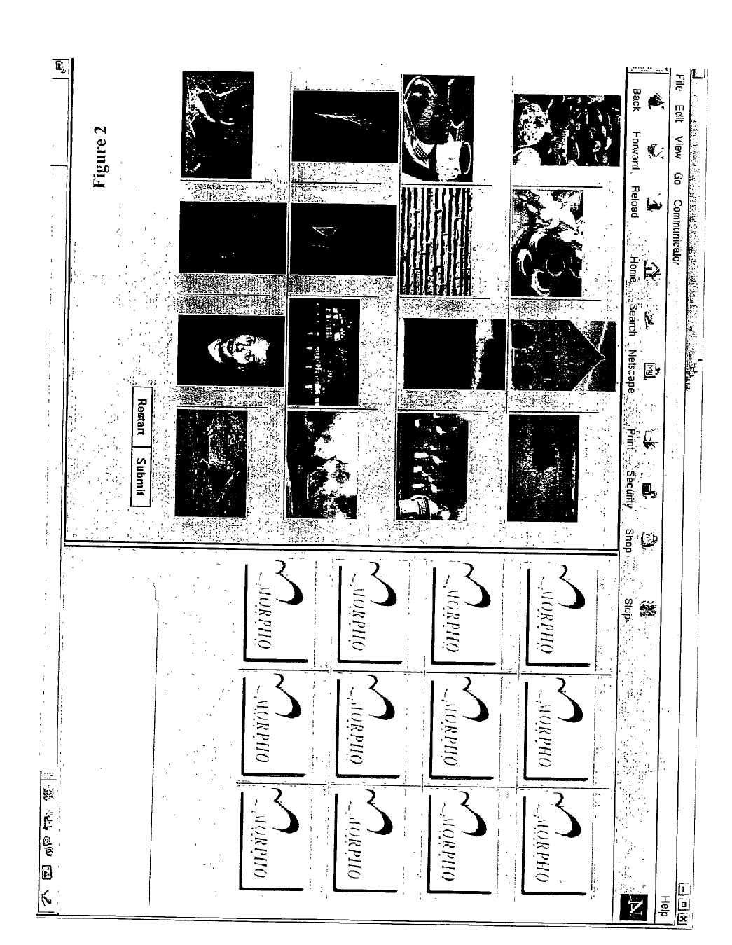

Screen 2. Sampling and relevance feedback continues. FIG. 2 shows the second screen. First, the similarity search frame displays what the system thinks will match the user's query concept at this time. As the figure indicates, eleven returned images fit the concept of “bird of paradise.” The user's query concept has been captured, though somewhat fuzzily. The user can ask the system to further refine the target concept by selecting relevant images in the learner frame. In this example, the user clicks on nine images (four images from the first row, the first and the third images from the second row, the third image from the third row, and the first two images from the last row) are relevant to the concept. After the user clicks on the submit button in the learner frame, the third screen is displayed.

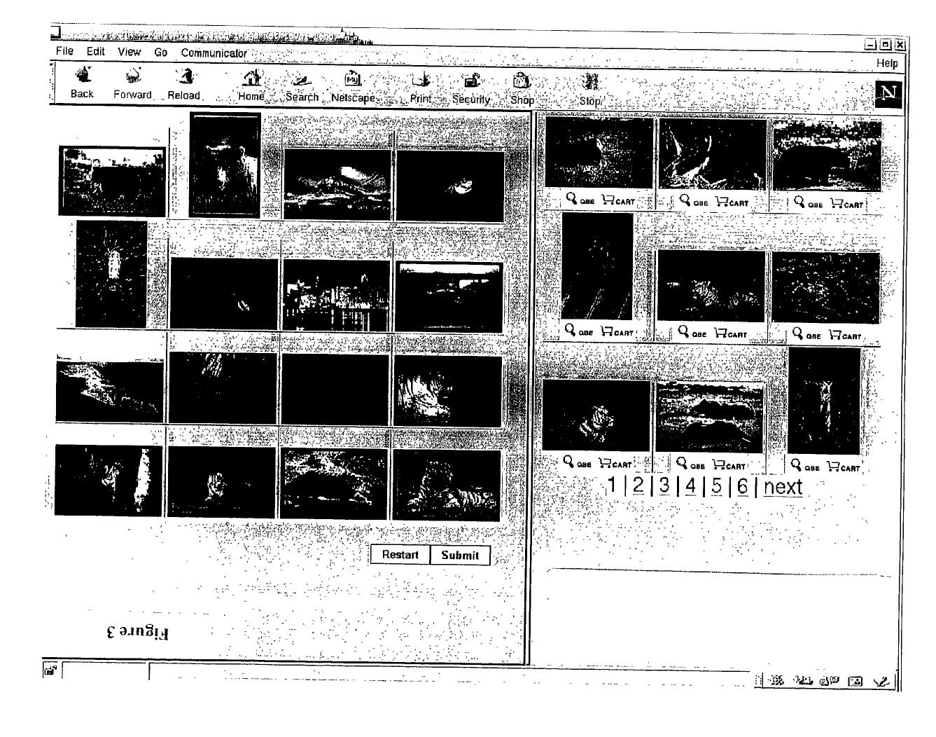

Screen 3. Sampling and relevance feedback ends. FIG. 3 shows that all, returned images in the similarity search frame fit the query concept (bird of paradise).

As observed, in two iterations, our system is able to retrieve fifteen relevant images from the image database. In this example, we used the keyword-based search engine to seed our perception-based search engine. The keyword-based search engine can be used to quickly identify the set of images relevant to the specified keywords. Based on these relevant images, the perception-based search engine can explore the feature space and discover more images relevant to the users' query concept. Note that our perception-based search system will also work without seedings from a keyword-based search engine.

The above example illustrates that the PBIR (Perception-Based Information Retrieval) paradigm achieves much higher recall because it overcomes the following limitations that the traditional keyword-only search paradigm encounters:

1. Subjective annotation. As we can see from the example, a “bird of paradise” image may be annotated as “bird,” “flower,” “hawaii,” and many other possible words. Using one of the words to conduct a keyword search cannot get the images labeled by the other words.

2. Terse annotation. The annotation of an image typically does not have as many words as that in a text document. With limited number of keywords, keyword annotation often cannot faithfully and completely capture images' semantics.

3. Incomplete query-concept formulation. A picture is worth more than a thousand words. Thus, a few query keywords can hardly characterize a complete query concept.

In summary, PBIR is effective in eliciting user input to quickly formulate subjective, personalized, and complete query concepts. PBIR can be used in many applications, including image and video searches, e-commerce produce searches, and face recognition applications. Here, we show two applications.

1. Video searches. PBIR can be applied to video searches. In the sampling phase, PBIR displays several video clips (instead of still images) in the learner frame to solicit user feedback. The user can play back the video clips, and mark the clips that match his or her query concept. By collecting the relevance feedback from the user, PBIR refines the target concept, and at the same time it returns the top-k videos matching the concept in the similarity search frame.

2. Music searches. Similarly, PBIR can be used to search in a music database. PBIR places several music sample-clips in the learner frame. A user listens to the clips and provides his or her feedback to PBIR. Based on the feedback, PBIR refines the target concept and uses it to retrieve matching music pieces in the similarity search frame.

### [INSERT FIG. 1 HERE]

### [INSERT FIG. 2 HERE]

### [INSERT FIG. 3 HERE]

2. Five Example Queries

This section presents five example queries to demonstrate the capability of PBIR in eliciting user information in connection with at least five different types of query concepts. Each example shows that the PBIR engine can be used to quickly zero in on a user's query concept. Users can seed a query with nothing, as all these examples show. Alternatively, users can seed a query with keywords or example images. Whichever seeding mode the user is in, the PBIR will quickly learning the subjective, personalized, and complete query concept in a small number of user iterations.

1. Heterogeneous Object Query “Flowers.”

2. General Category Query “Animals.”

3. Specific Object in a Category Query “Tigers.”

4. E-Commerce Query “Hats.”

5. Face Recognition Query “Vincent van Gogh.”

2.1 Query Animals

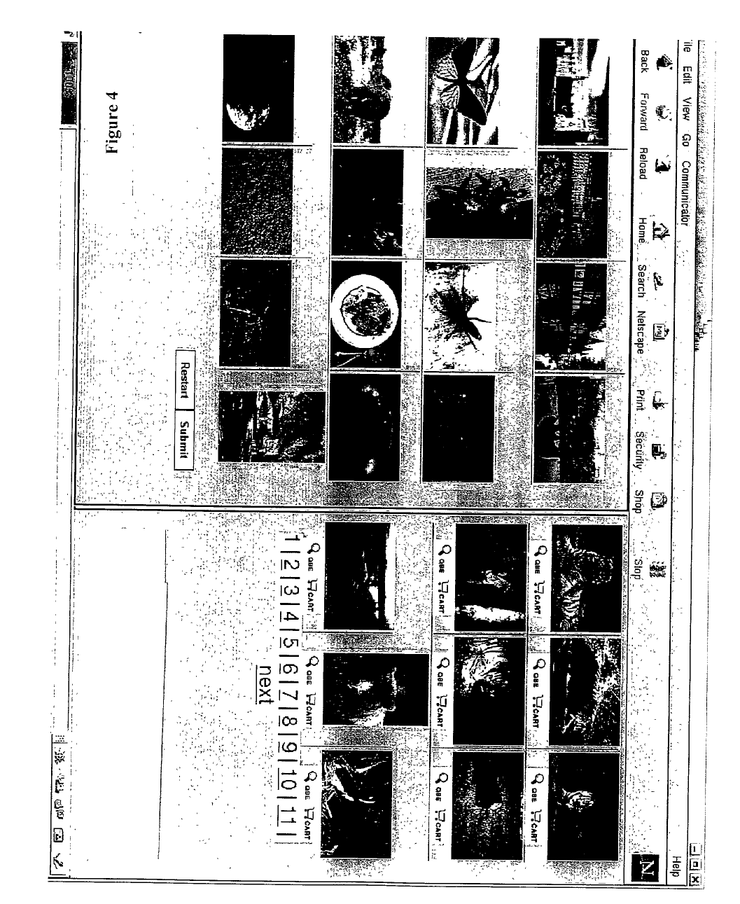

The learning steps for grasping the concept “animals” involves three steps that are illustrated in FIGS. 4-10.

(a) Query Concept Learning.

Screen 1. Initial Screen. The system presents the initial screen to the user as shown in FIG. 4. The screen is split into two frames horizontally. On the left-hand side of the screen is the learner frame; on the right-hand side is the search result frame. Through the learner frame, the system learns what the user wants via an active learning process. The search result frame displays images that match the user's query concept as the system currently understands it.

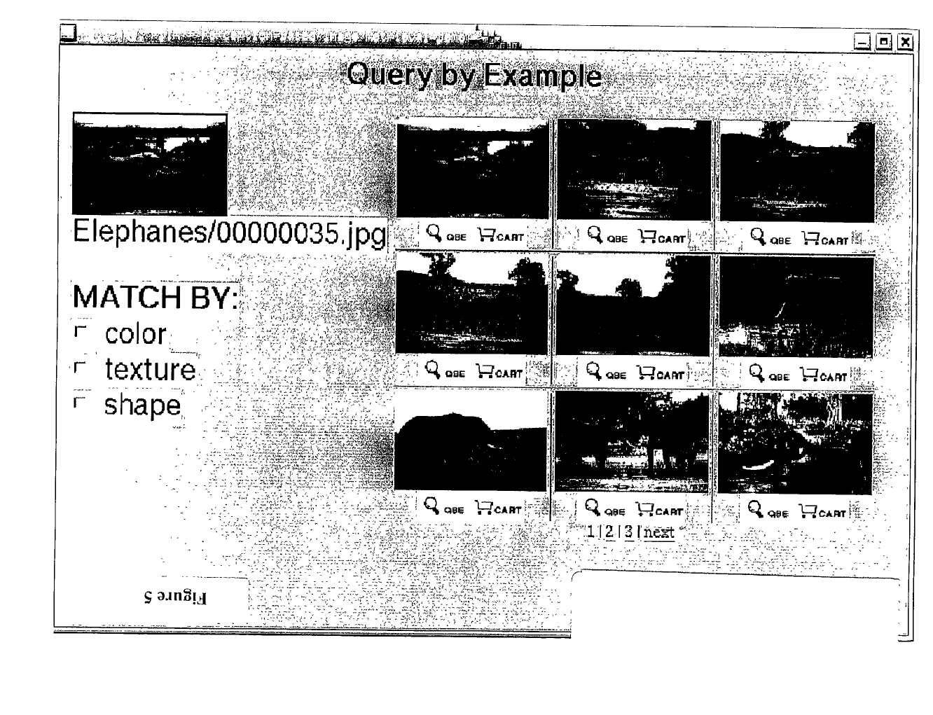

Screen 2. Sampling and relevance feedback starts. Once the user clicks the “submit” button in the initial frame, the active learning step commences to learn what the user wants. The system presents a number of samples in the learner frame, and the user marks images that are relevant to his or her query concept by clicking on the relevant images. As shown in FIG. 5, two images (the last image of the first row and the first image of the last row) are selected as relevant, and the rest of the unmarked images are considered irrelevant. The user indicates the end of his or her selection by clicking on the submit button in the learner screen. This action brings up the next screen.

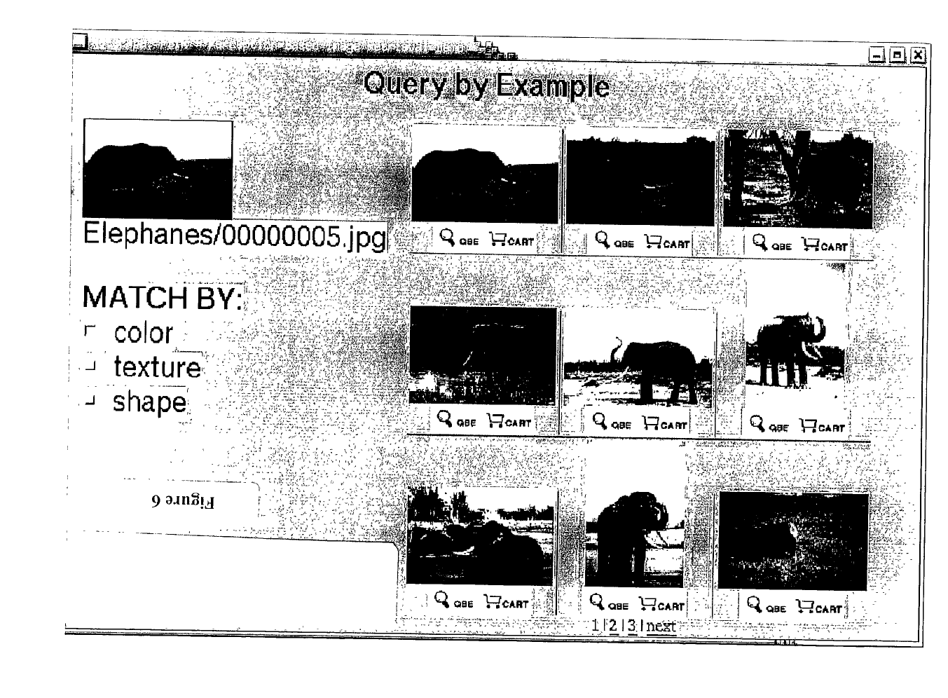

Screen 3. Sampling and relevance feedback continues. FIG. 6 shows the third screen. First, the search result frame displays what the system thinks will match the user's query concept at this time. As the figure indicates, seven returned images fit the concept of “animals.” The user's query concept has been captured, though somewhat fuzzily The user can ask the system to further refine the target concept by selecting relevant images in the learner frame. In this example, eight images (the first two images of the first row, the last image of the second row, the last image of the third row, and the four images of the last row) are relevant to the concept. After the user clicks on the submit button in the learner frame, the fourth screen is displayed.

### [INSERT FIG. 4 HERE]

### [INSERT FIG. 5 HERE]

### [INSERT FIG. 6 HERE]

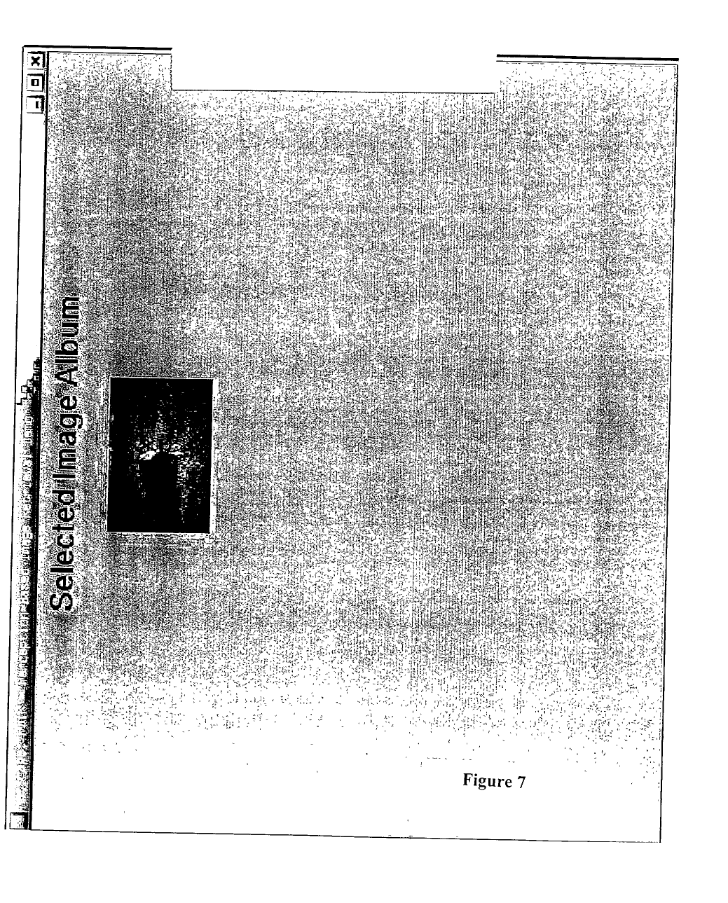

### [INSERT FIG. 7 HERE]

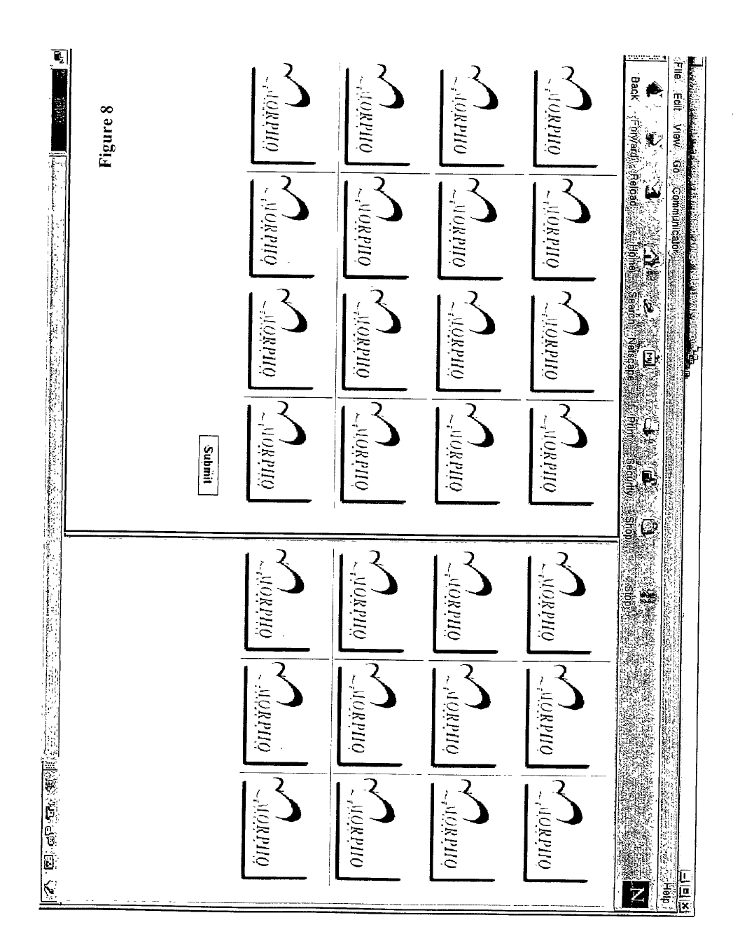

### [INSERT FIG. 8 HERE]

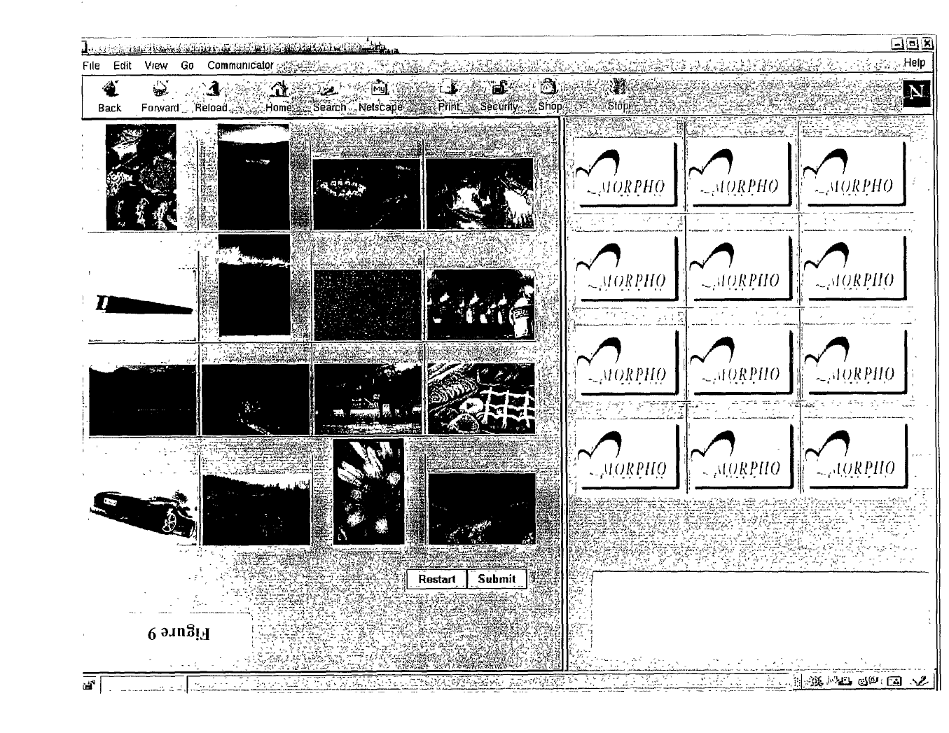

### [INSERT FIG. 9 HERE]

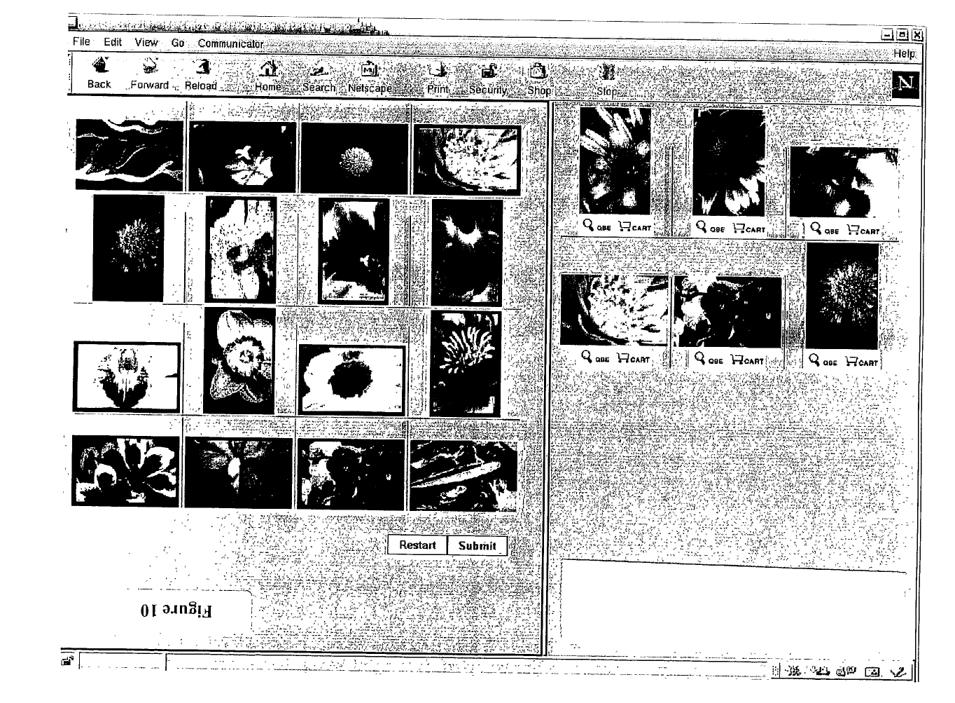

### [INSERT FIG. 10 HERE]

Screen 4. Sampling and relevance feedback ends. FIG. 7 shows that all nine images fit the query concept (animals).

(a) Query by Example (QBE).

Screen 5. Query-by-example starts. At any time, the user can click on the QBE icon below each image on the search result screen to request images that appear similar to the selected image. This step allows the user to zoom into a specific set of images that match some appearance criteria, such as color distribution, textures, and shapes. For example, after we click the QBE icon below the first image of the third row on the right-hand side frame in FIG. 7, the system pops up a query-by-example window as shown in FIG. 8. Users can select their desired matching criteria by clicking on the check box shown on the query-by-example window. The default matching criteria are based on combinations of color distribution, textures, and shapes.

Screen 6. Change matching criteria. The user can choose their desired matching criteria by clicking on the corresponding check boxes. By clicking on the first elephant image of the third row on the query-by-example window, FIG. 9 shows another query-by-example image retrieval using “color” as the matching criterion.

(a) Image Collection.

Screen 7. Image collection. At any time, the user can click on the CART icon below each image on the search result screen to put the image into an album. In this way, the user can collect their favorite images in an album. For example, in FIG. 9, by clicking on the CART icon of the last image of the last row, the selected images are put in an album as shown in FIG. 10.

2.2 Query Tigers

The learning steps for grasping the concept “tigers” involves three steps that are illustrated in the following seven figures.

(a) Query Concept Learning.

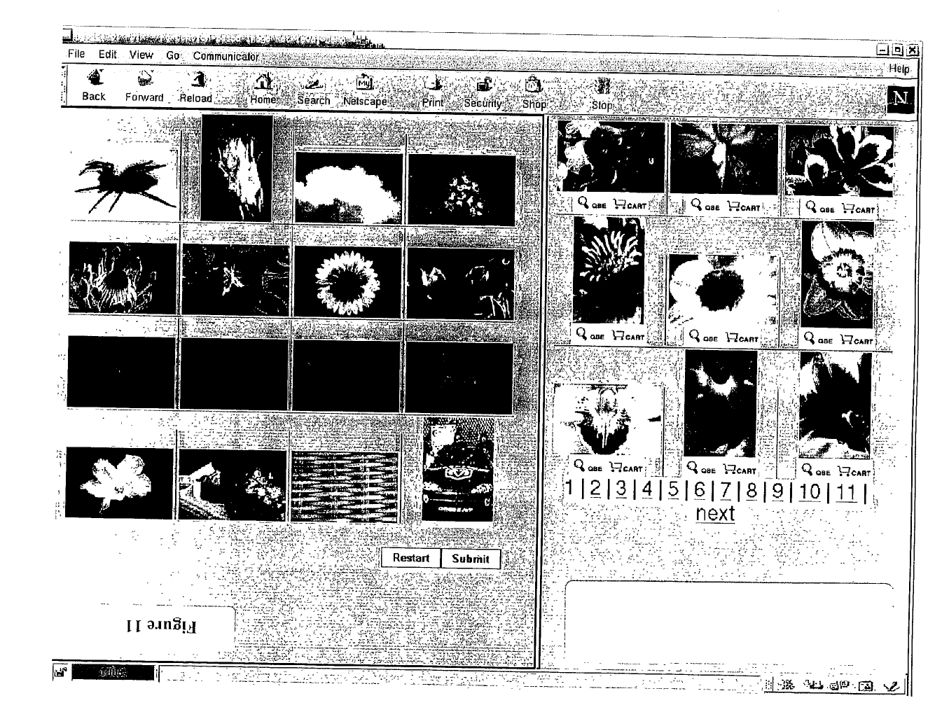

Screen 1. Initial Screen. The system presents the initial screen to the user as shown in FIG. 11. The screen is split into two frames horizontally. On the left-hand side of the screen is the learner frame; on the right-hand side is the search result frame. Through the learner frame, the system learns what the user wants via an active learning process. The search result frame displays images that match the user's query concept.

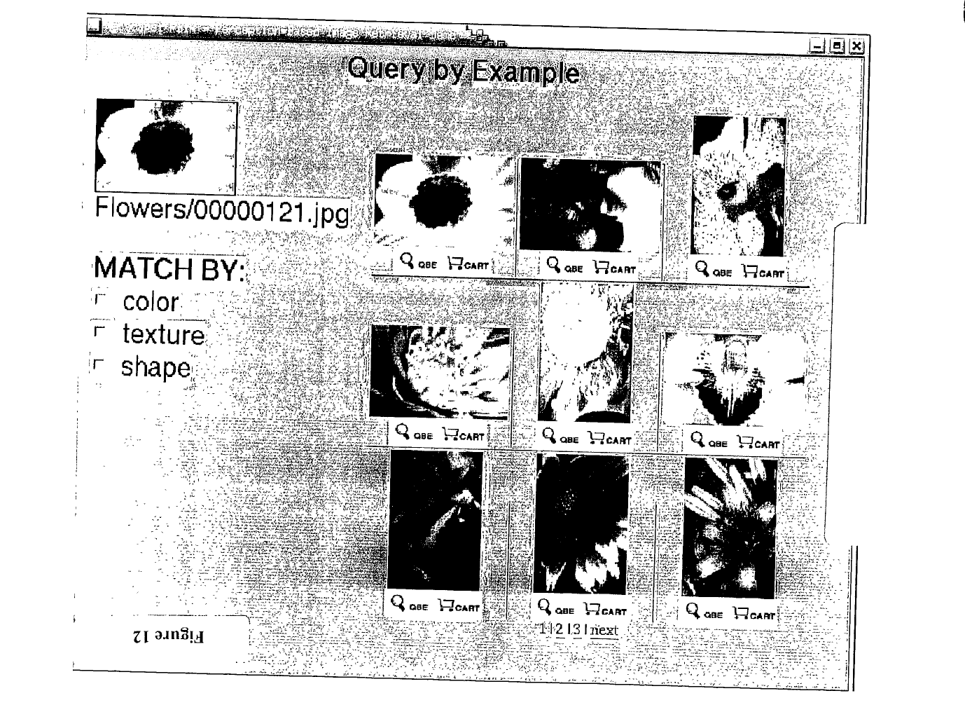

Screen 2. Sampling and relevance feedback starts. Once the user clicks the “submit” button in the initial frame, the active learning step commences to learn what the user wants. The system presents a number of samples in the learner frame, and the user marks images that are relevant to his or her query concept by clicking on the relevant images. As shown in FIG. 12, one image (the first image of the third row) is selected as relevant, and the rest of the unmarked images are considered irrelevant. The user indicates the end of his or her selection by clicking on the submit button in the learner screen. This action brings up the next screen.

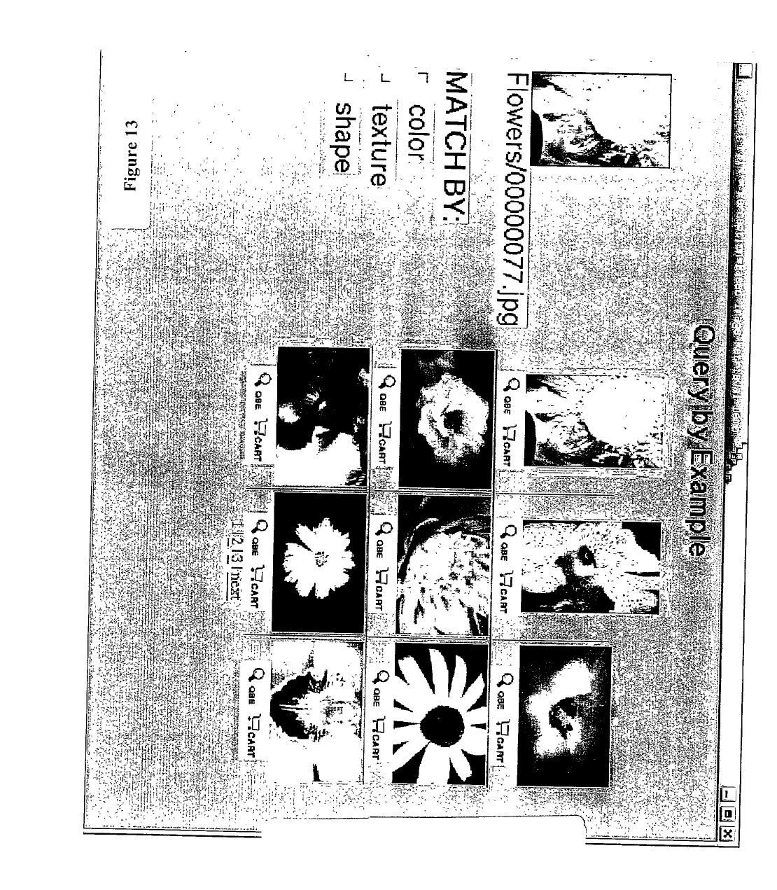

Screen 3. Sampling and relevance feedback continues. FIG. 13 shows the third screen. First, the search result frame displays what the system thinks will match the user's query concept at this time. As the figure indicates, two returned images fit the concept of “tigers.” The user's query concept has been captured, though somewhat fuzzily. The user can ask the system to further refine the target concept by selecting relevant images in the learner frame. In this example, eight images (four image of the second row and four images from the third row) is relevant to the concept. After the user clicks on the submit button in the learner frame, the fourth screen is displayed.

### [INSERT FIG. 11 HERE]

### [INSERT FIG. 12 HERE]

### [INSERT FIG. 13 HERE]

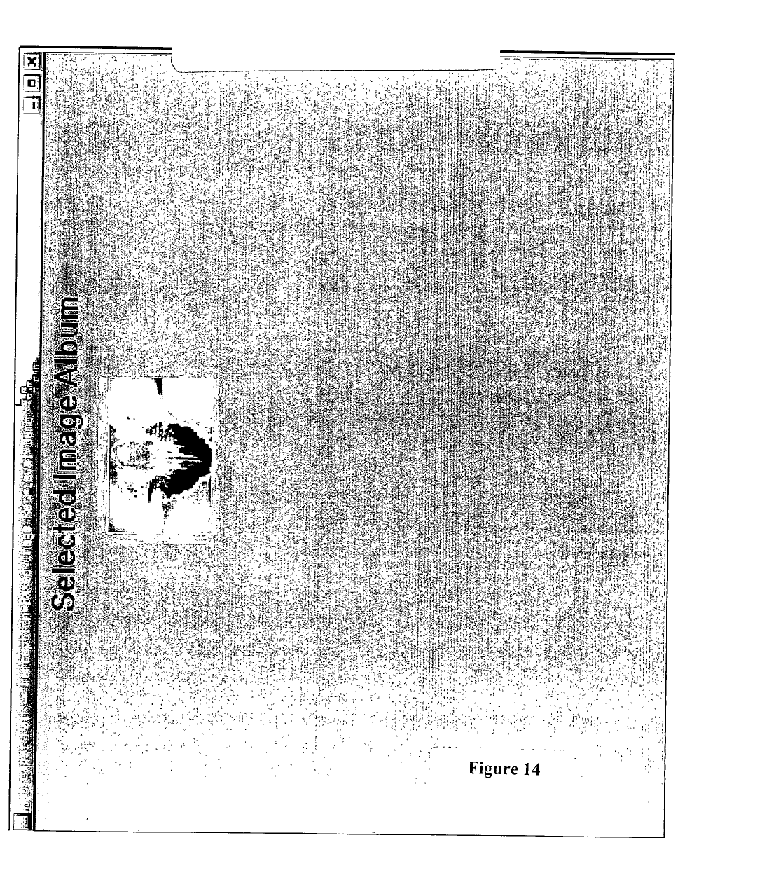

### [INSERT FIG. 14 HERE]

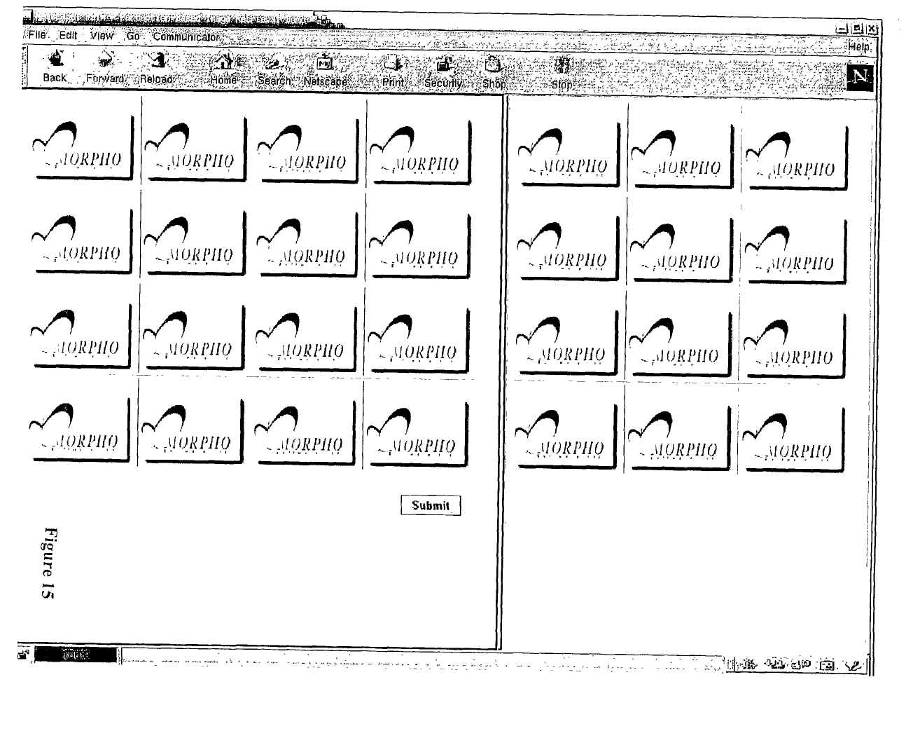

### [INSERT FIG. 15 HERE]

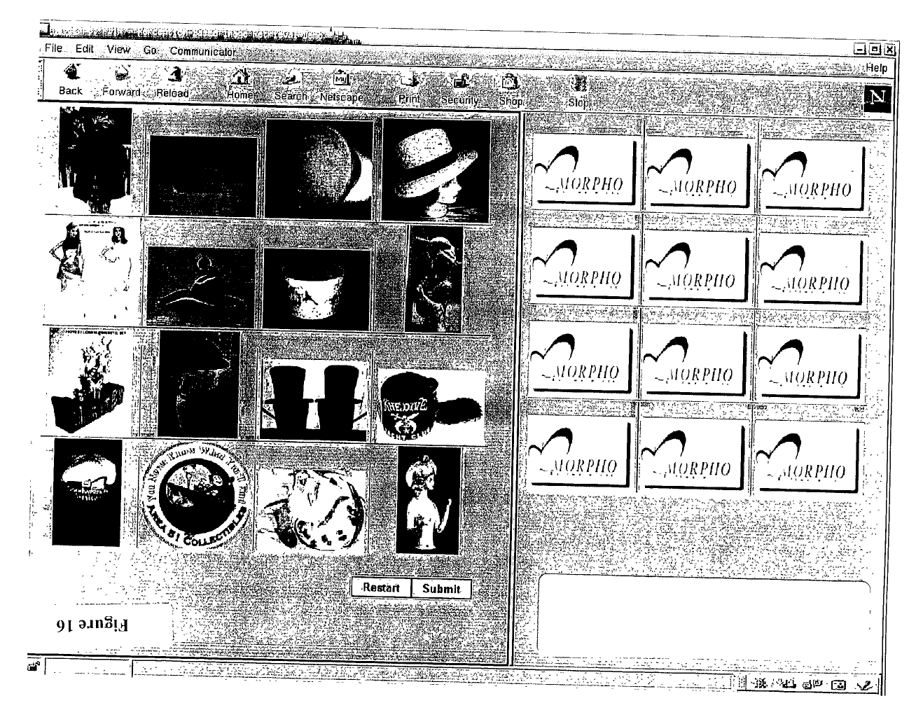

### [INSERT FIG. 16 HERE]

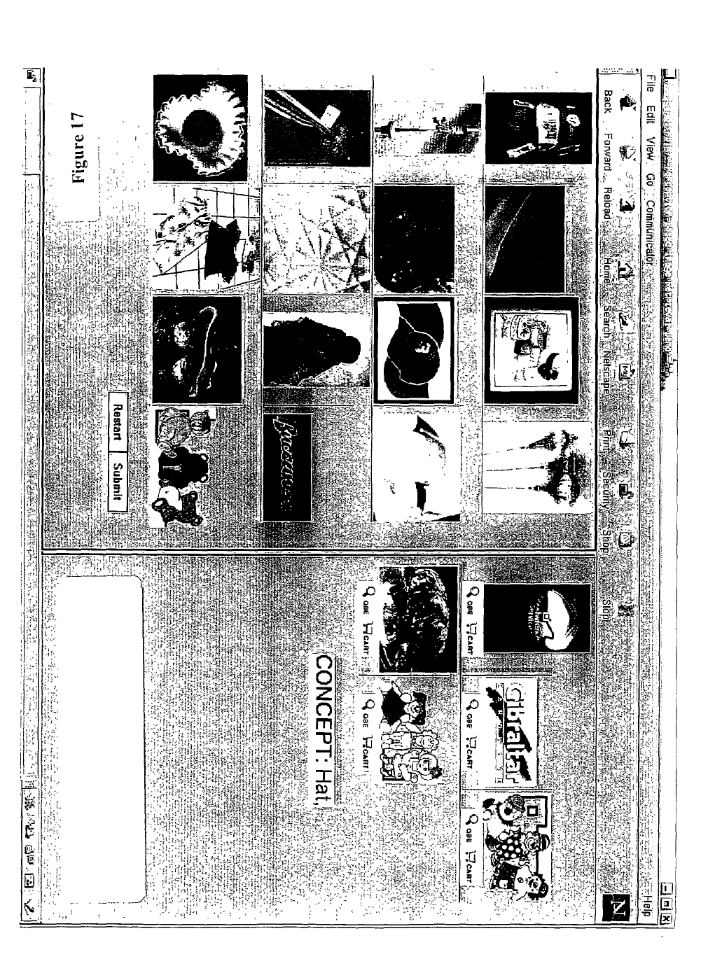

### [INSERT FIG. 17 HERE]

Screen 4. Sampling and relevance feedback ends. FIG. 14 shows that all nine images fit the query concept (tigers).

(a) Query by Example (QBE).

Screen 5. Query-by-example starts. At any time, the user can click on the QBE icon below each image on the search result screen to request images that appear similar to the selected image. This step allows the user to zoom into a specific set of images that match some appearance criteria, such as color distribution, textures, and shapes. For example, after we click the QBE icon below the second tiger image of the first row on the right-hand side frame in FIG. 14, the system pops up a query-by-example window as shown in FIG. 15. Users can select their desired matching criteria by clicking on the check box shown on the query-by-example window. The default matching criteria are based on combinations of color distribution, textures, and shapes.

Screen 6. Change matching criteria. The user can choose their desired matching criteria by clicking on the corresponding check boxes. By clicking on the last tiger image of the third row on the query-by-example window, FIG. 16 shows another query-by-example image retrieval using “color” as the matching criterion.

(a) Image Collection.

Screen 7. Image collection. At any time, the user can click on the CART icon below each image on the search result screen to put the image into an album. In this way, the user can collect their favorite images in an album. For example, in FIG. 16, by clicking on the CART icon of the first image of the second row, the selected images are put in an album as shown in FIG. 17.

2.3 Query Flowers

The learning steps for grasping the concept “flowers” involves three steps that are illustrated in the following seven figures.

(a) Query Concept Learning.

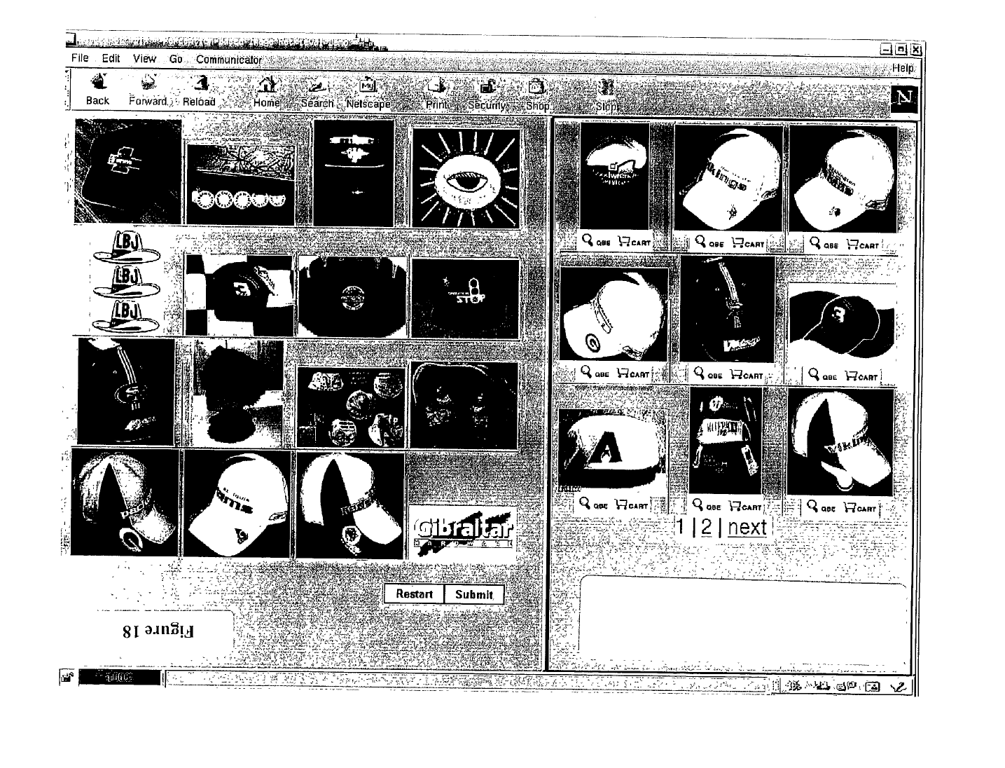

Screen 1. Initial Screen. The system presents the initial screen to the user as shown in FIG. 18. The screen is split into two frames horizontally. On the left-hand side of the screen is the learner frame; on the right-hand side is the search result frame. Through the learner frame, the system learns what the user wants via an active learning process. The search result frame displays images that match the user's query concept.

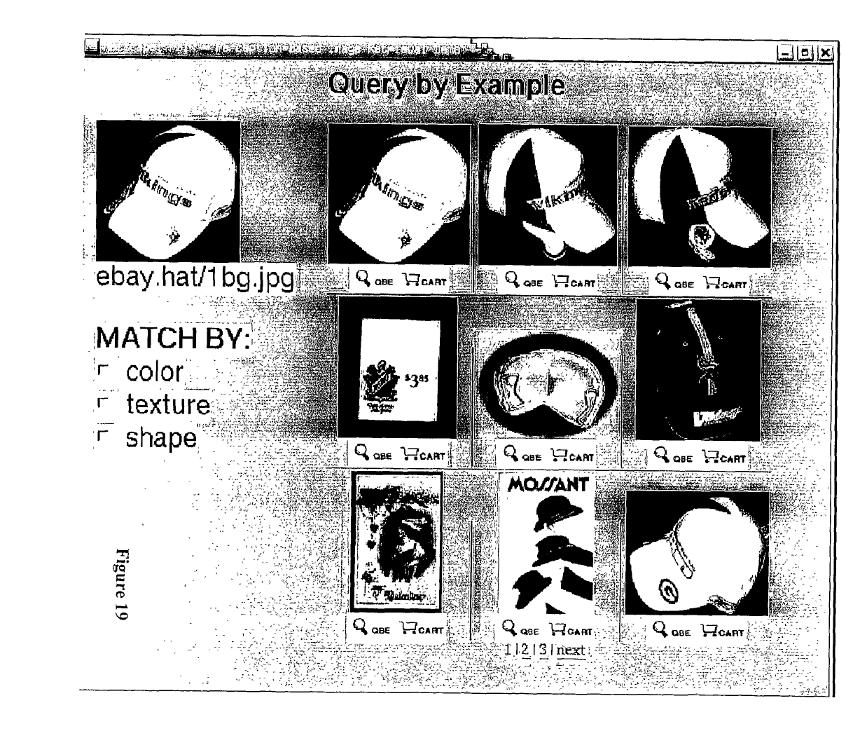

Screen 2. Sampling and relevance feedback starts. Once the user clicks the “submit” button in the initial frame, the active learning step commences to learn what the user wants. The system presents a number of samples in the learner frame, and the user marks images that are relevant to his or her query concept by clicking on the relevant images. As shown in FIG. 19, one image (the third image of the last row) is selected as relevant, and the rest of the unmarked images are considered irrelevant. The user indicates the end of his or her selection by clicking on the submit button in the learner screen. This action brings up the next screen.

### [INSERT FIG. 18 HERE]

### [INSERT FIG. 19 HERE]

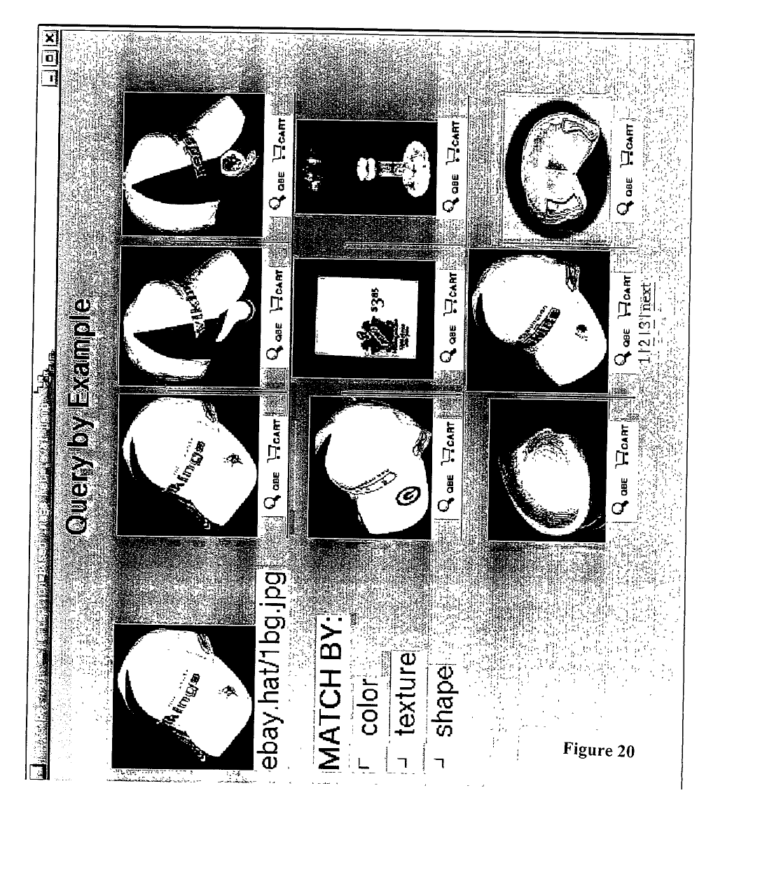

### [INSERT FIG. 20 HERE]

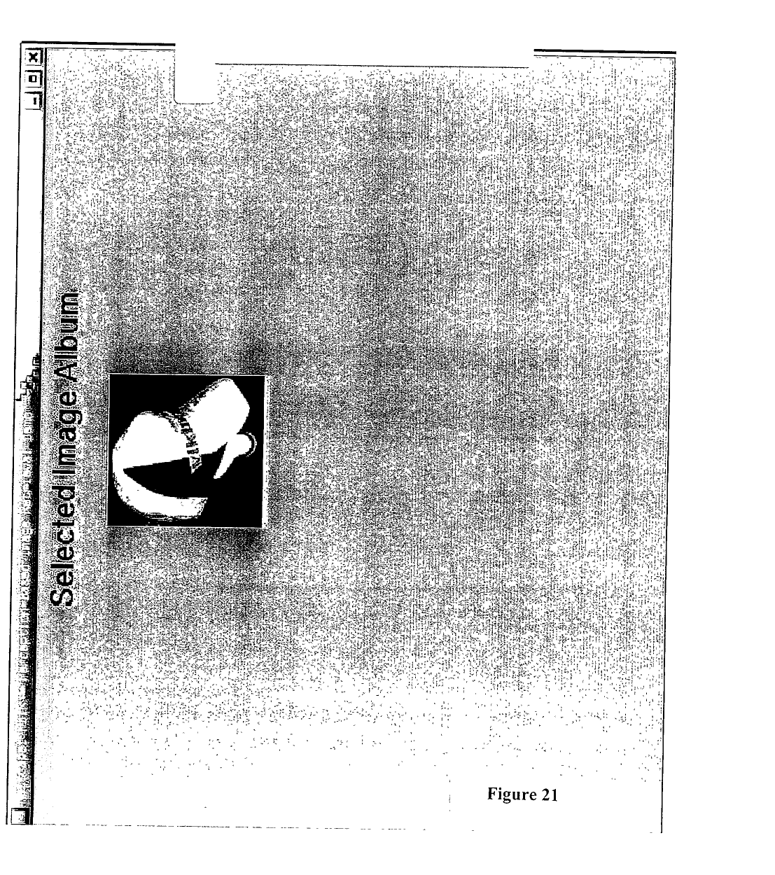

### [INSERT FIG. 21 HERE]

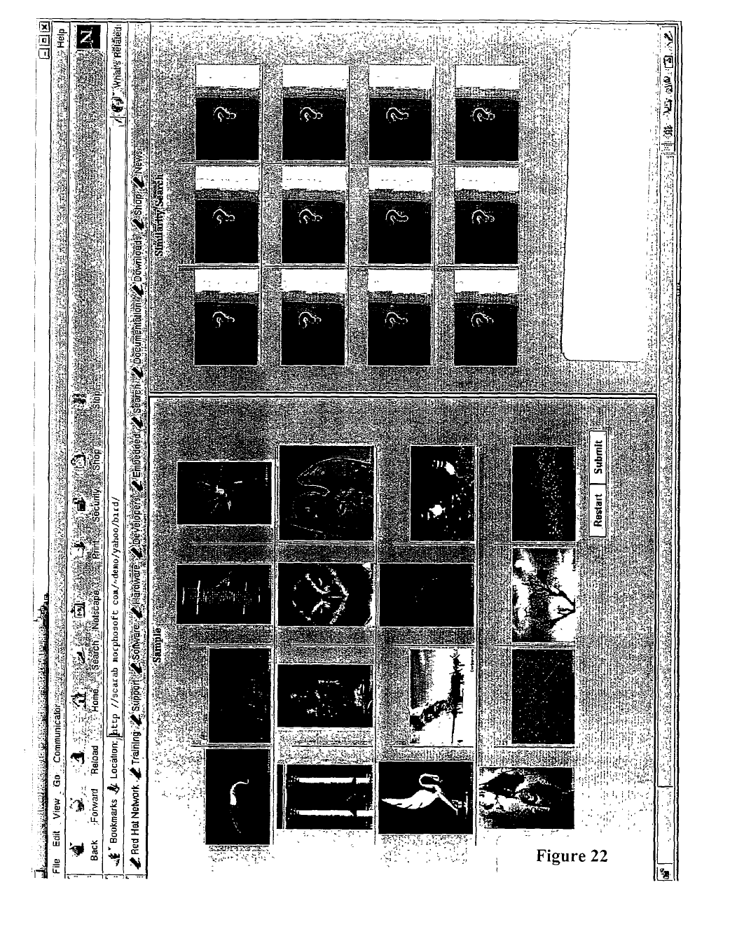

### [INSERT FIG. 22 HERE]

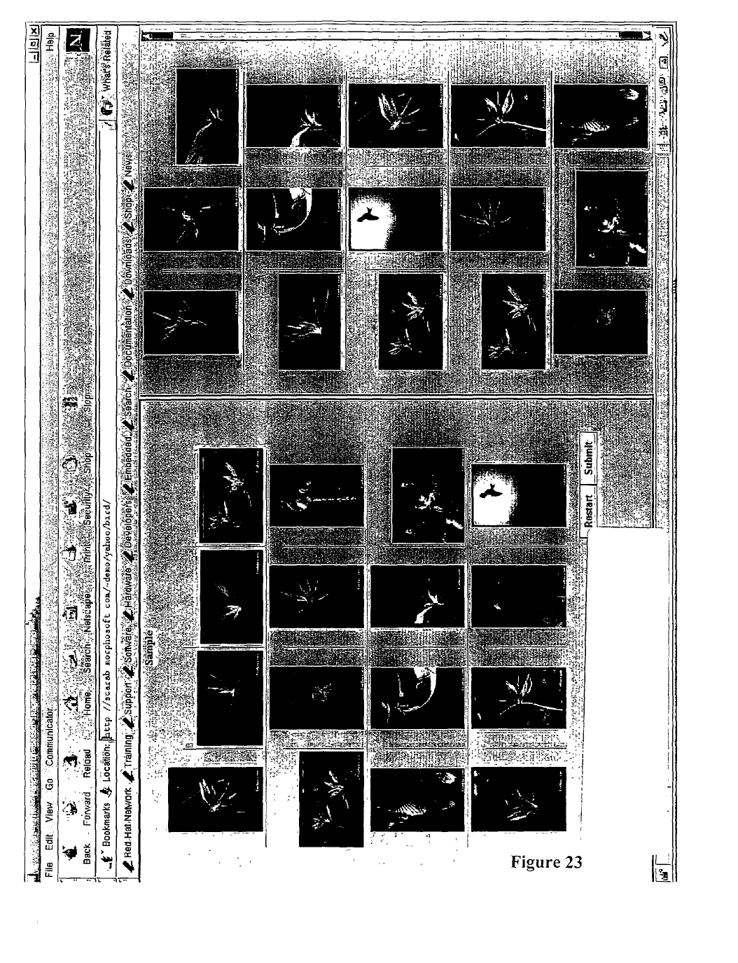

### [INSERT FIG. 23 HERE]

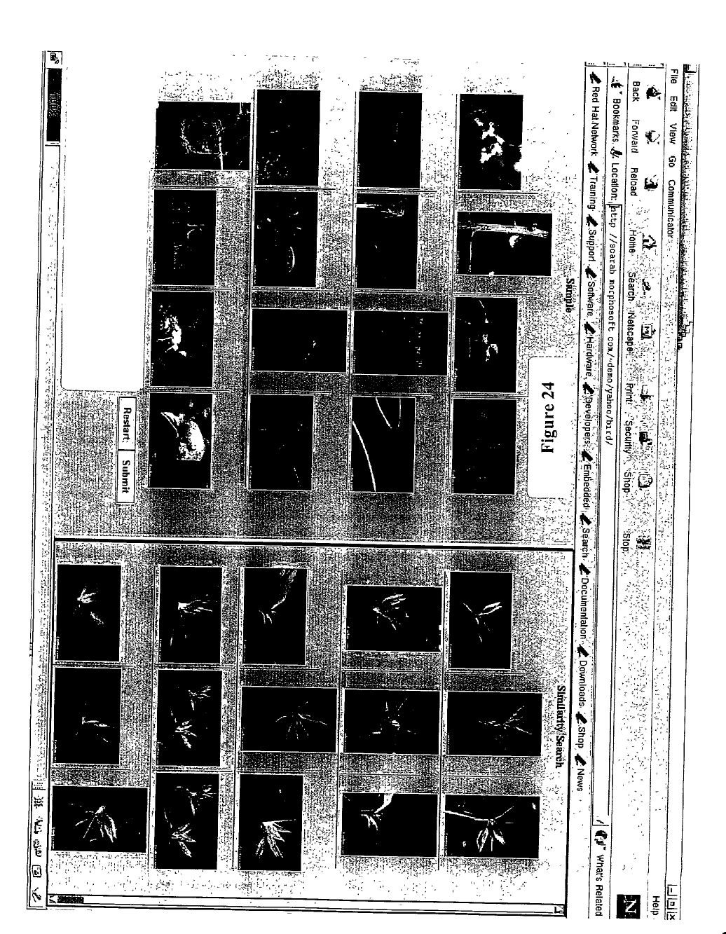

### [INSERT FIG. 24 HERE]

Screen 3. Sampling and relevance feedback continues. FIG. 20 shows the third screen. First, the search result frame displays what the system thinks will match the user's query concept at this time. As the figure indicates, six returned images fit the concept of “flowers.” The user's query concept has been captured, though somewhat fuzzily. The user can ask the system to further refine the target concept by selecting relevant images in the learner frame. In this example, fourteen images (the last three images of the first row, the four images of the second row, the four images of the third row, and the first three images of the last row) are relevant to the concept. After the user clicks on the submit button in the learner frame, the fourth screen is displayed.

Screen 4. Sampling and relevance feedback ends. FIG. 21 shows that all nine images fit the query concept (flowers).

(a) Query by Example (QBE).

Screen 5. Query-by-example starts. At any time, the user can click on the QBE icon below each image on the search result screen to request images that appear similar to the selected image. This step allows the user to zoom into a specific set of images that match some appearance criteria, such as color distribution, textures, and shapes. For example, after we click the QBE icon below the second flower image of the second row on the right-hand side frame in FIG. 21, the system pops up a query-by-example window as shown in FIG. 22. Users can select their desired matching criteria by clicking on the check box shown on the query-by-example window. The default matching criteria are based on combinations of color distribution, textures, and shapes.

Screen 6. Change matching criteria. The user can choose their desired matching criteria by clicking on the corresponding check boxes. By clicking on the second image of the second row on the query-by-example window, FIG. 23 shows another query-by-example image retrieval using “color” as the matching criterion.

(a) Image Collection.

Screen 7. Image collection. At any time, the user can click on the CART icon below each image on the search result screen to put the image into an album. In this way, the user can collect their favorite images in an album. For example, in FIG. 23, by clicking on the CART icon of the last image of the last row, the selected images are put in an album as shown in FIG. 24.

2.4 Query Hats

This example shows an e-commerce scenario. A user is interested in searching for sports caps in an e-commerce site. Unfortunately, typing in the keyword “hats” returns a large number of hats, and most of them are irrelevant to the query concept. Our PBIR engine is able to zoom into what the user wants in this large dataset in a small number of user feedback rounds. If the user were to do a sequential search to find his or her desired items, the user would probably leave the site without buying anything.

The learning steps for grasping the concept “sport hats” involves three steps that are illustrated in the following seven figures.

(a) Query Concept Learning.

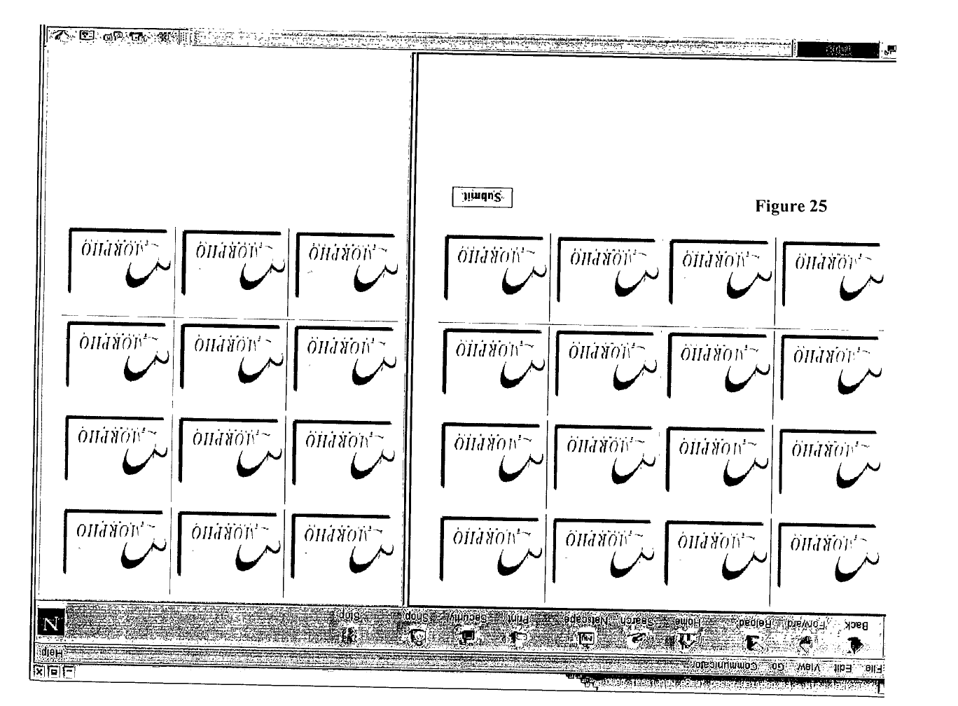

Screen 1. Initial Screen. The system presents the initial screen to the user as shown in FIG. 25. The screen is split into two frames horizontally. On the left-hand side of the screen is the learner frame; on the right-hand side is the search result frame. Through the learner frame, the system learns what the user wants via an active learning process. The search result frame displays images that match the user's query concept.

### [INSERT FIG. 25 HERE]

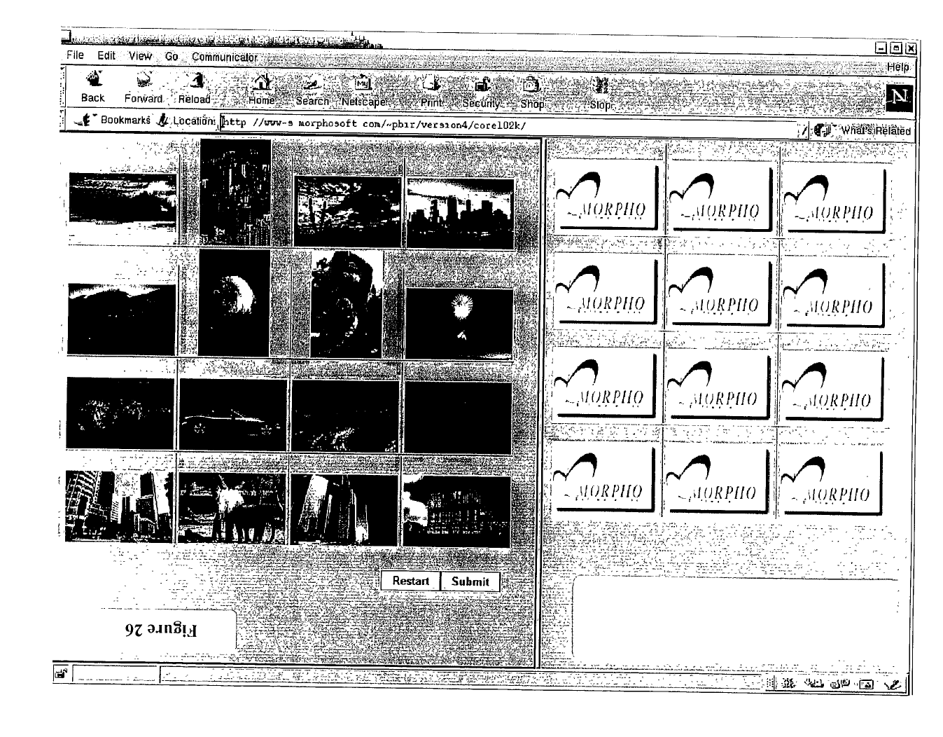

### [INSERT FIG. 26 HERE]

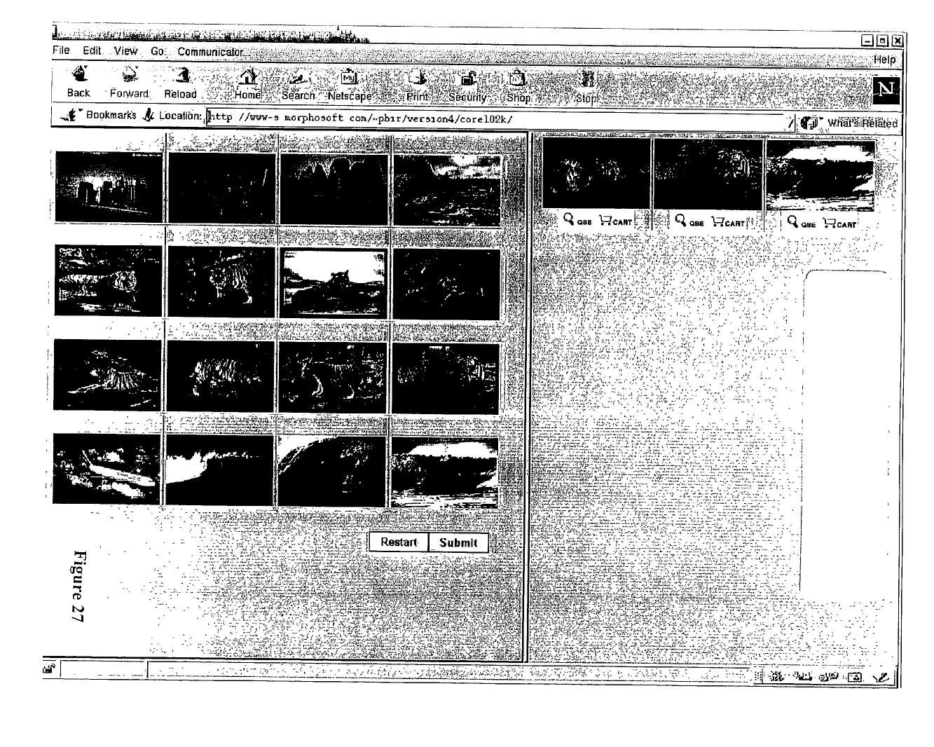

### [INSERT FIG. 27 HERE]

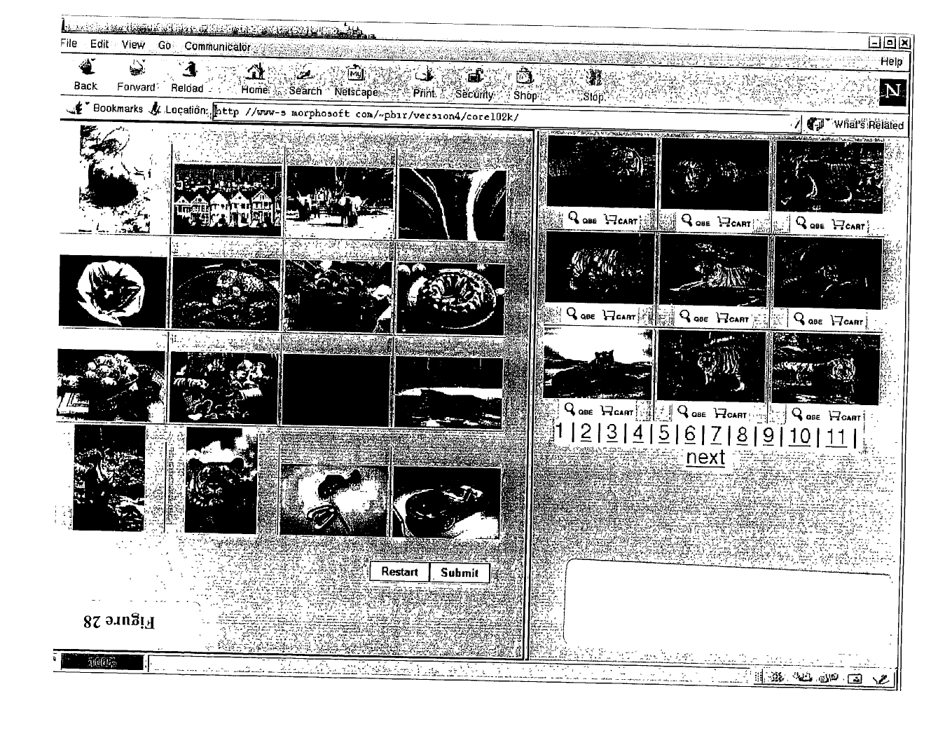

### [INSERT FIG. 28 HERE]

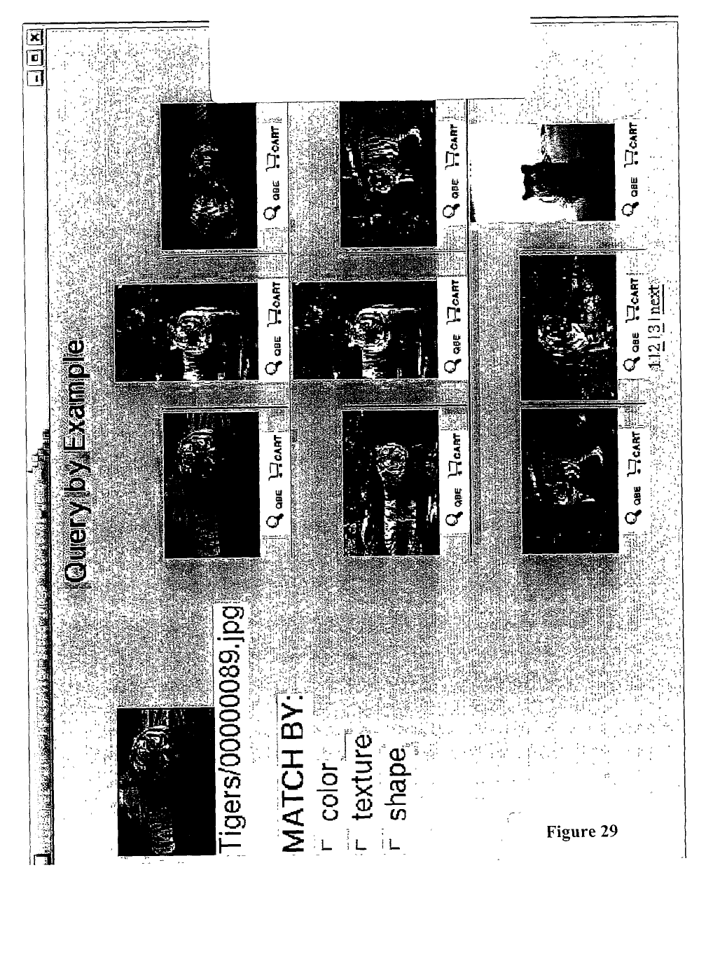

### [INSERT FIG. 29 HERE]

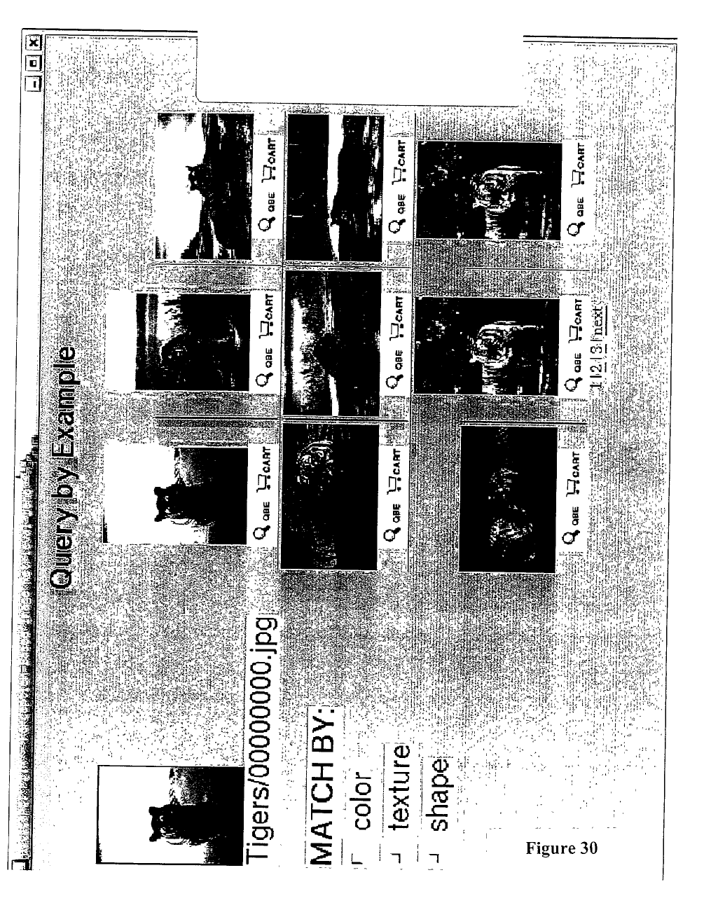

### [INSERT FIG. 30 HERE]

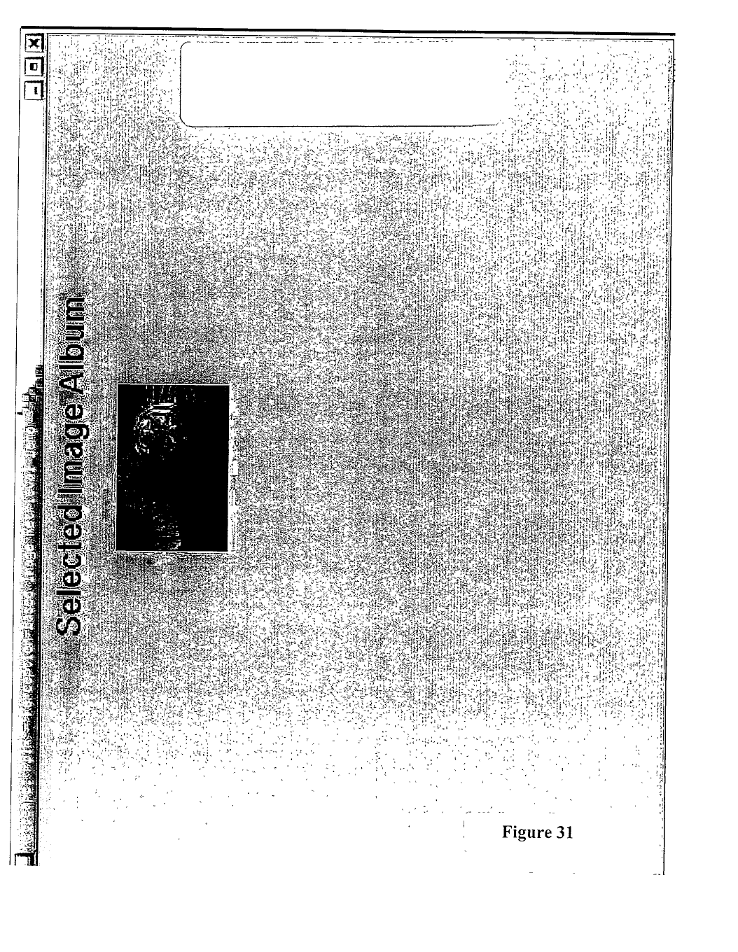

### [INSERT FIG. 31 HERE]

Screen 2. Sampling and relevance feedback starts. Once the user clicks the “submit” button in the initial frame, the active learning step commences to learn what the user wants. The system presents a number of samples in the learner frame, and the user marks images that are relevant to his or her query concept by clicking on the relevant images. As shown in FIG. 6, one image (the first image of the last row) are selected as relevant, and the rest of the unmarked images are considered irrelevant. The user indicates the end of his or her selection by clicking on the submit button in the learner screen. This action brings up the next screen.

Screen 3. Sampling and relevance feedback continues. FIG. 27 shows the third screen. First, the search result frame displays what the system thinks will match the user's query concept at this time. As the figure indicates, only one returned images fit the concept of “sport hats.” The user's query concept has been captured, though somewhat fuzzily. The user can ask the system to further refine the target concept by selecting relevant images in the learner frame. In this example, two more images (the first image of the first row and the third image of the second row) are relevant to the concept. After the user clicks on the submit button in the learner frame, the fourth screen is displayed.

Screen 4. Sampling and relevance feedback ends. FIG. 28 shows that all nine images fit the query concept (sport hats).

(a) Query by Example (QBE).

Screen 5. Query-by-example starts. At any time, the user can click on the QBE icon below each image on the search result screen to request images that appear similar to the selected image. This step allows the user to zoom into a specific set of images that match some appearance criteria, such as color distribution, textures, and shapes. For example, after we click the QBE icon below the second image of the first row on the right-hand side frame in FIG. 28, the system pops up a query-by-example window as shown in FIG. 29. Users can select their desired matching criteria by clicking on the check box shown on the query-by-example window. The default matching criteria are based on combinations of color distribution, textures, and shapes.

Screen 6. Change matching criteria. The user can choose their desired matching criteria by clicking on the corresponding check boxes. By clicking on the first image of the first row on the query-by-example window, FIG. 30 shows another query-by-example image retrieval using “color” as the matching criterion.

(a) Image Collection.

Screen 7. Image collection. At any time, the user can click on the CART icon below each image on the search result screen to put the image into an album. In this way, the user can collect their favorite images in an album. For example, in FIG. 30, by clicking on the CART icon of the second image of the first row, the selected images are put in an album as shown in FIG. 31.

2.5 Query Vincent van Gough

The learning steps for grasping the concept “Vincent van Gogh” involves three steps that are illustrated in the following seven figures.

1. Query Concept Learning.

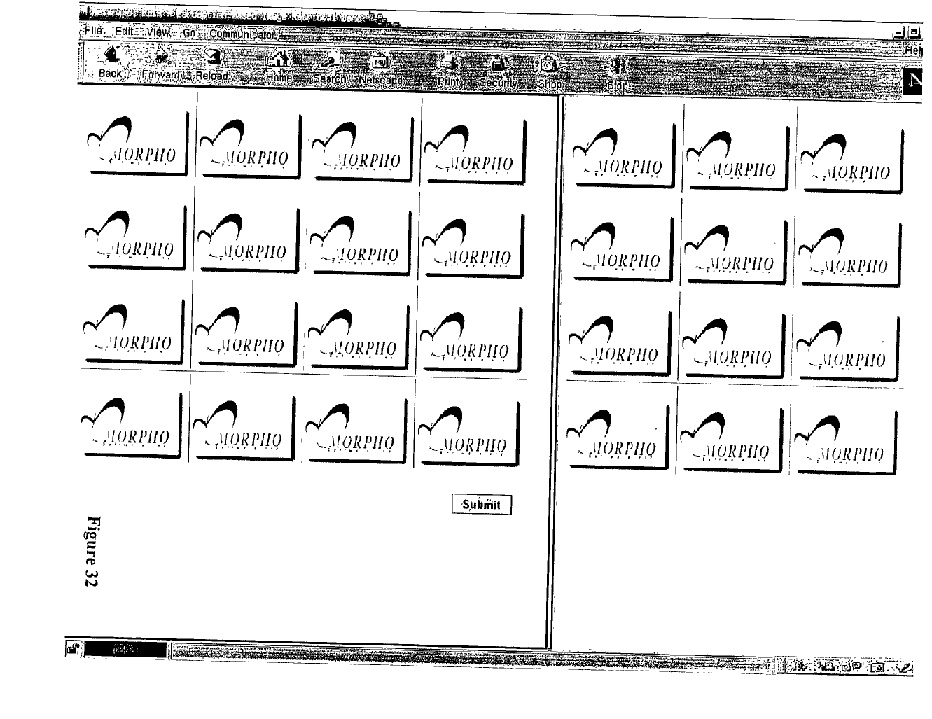

### [INSERT FIG. 32 HERE]

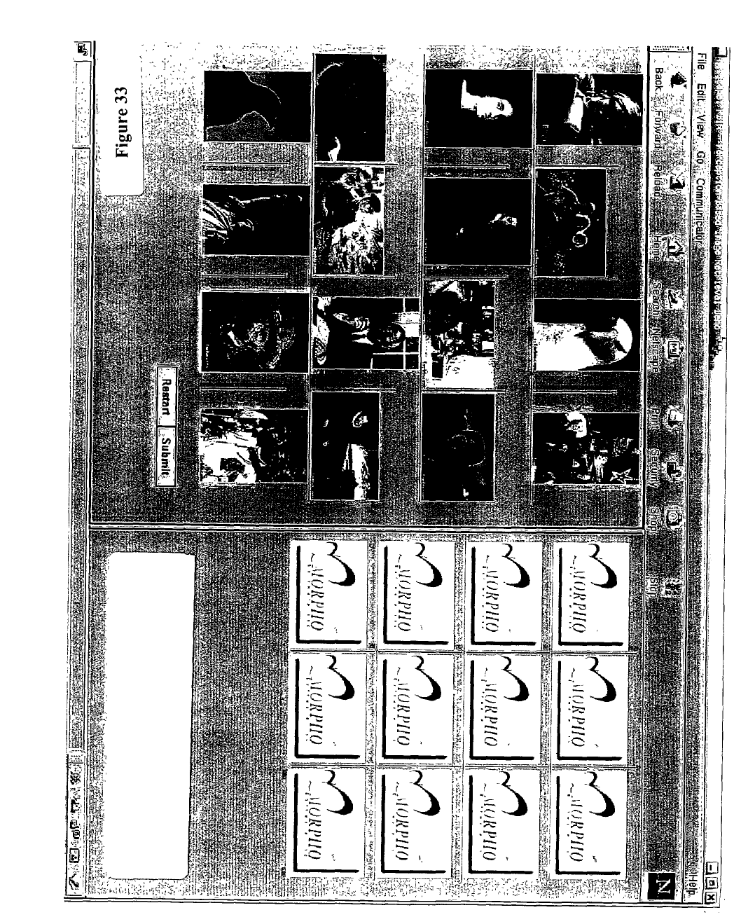

### [INSERT FIG. 33 HERE]

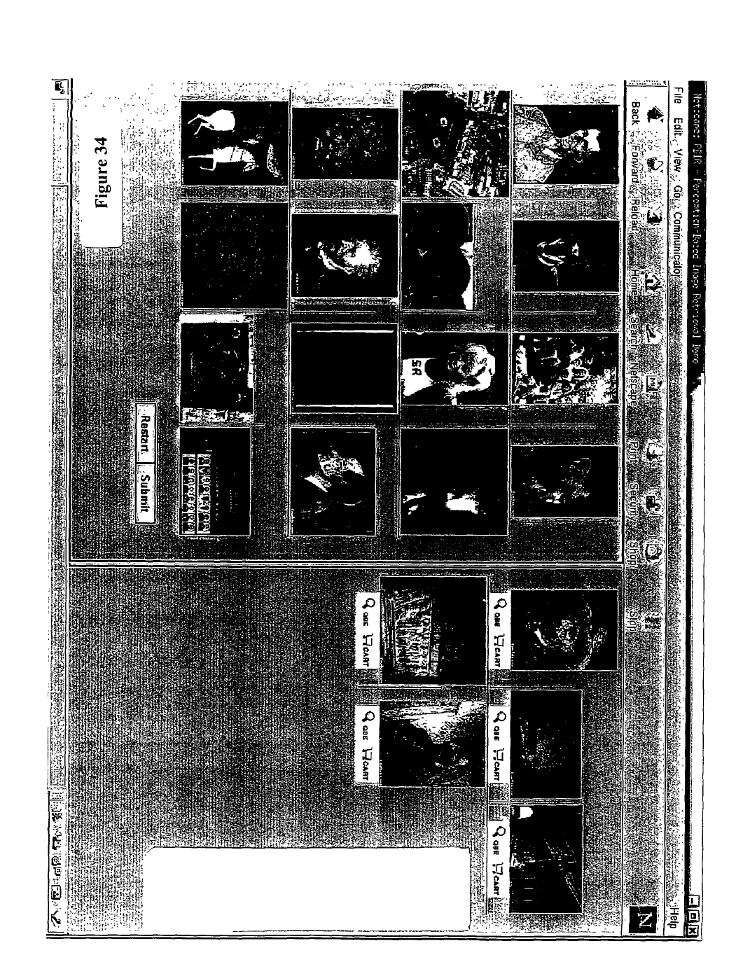

### [INSERT FIG. 34 HERE]

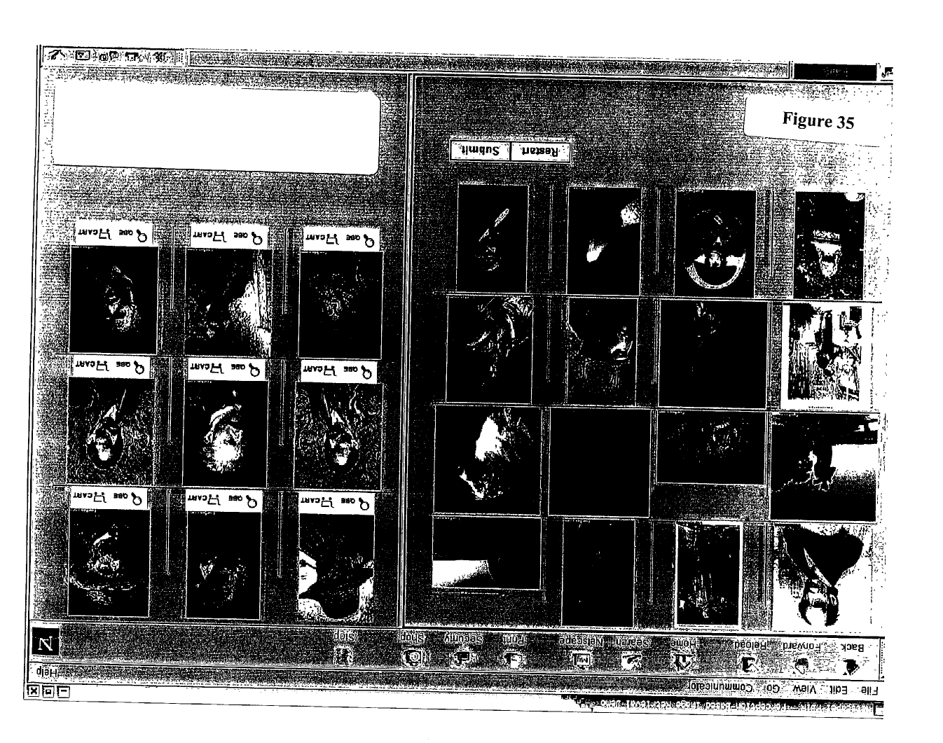

### [INSERT FIG. 35 HERE]

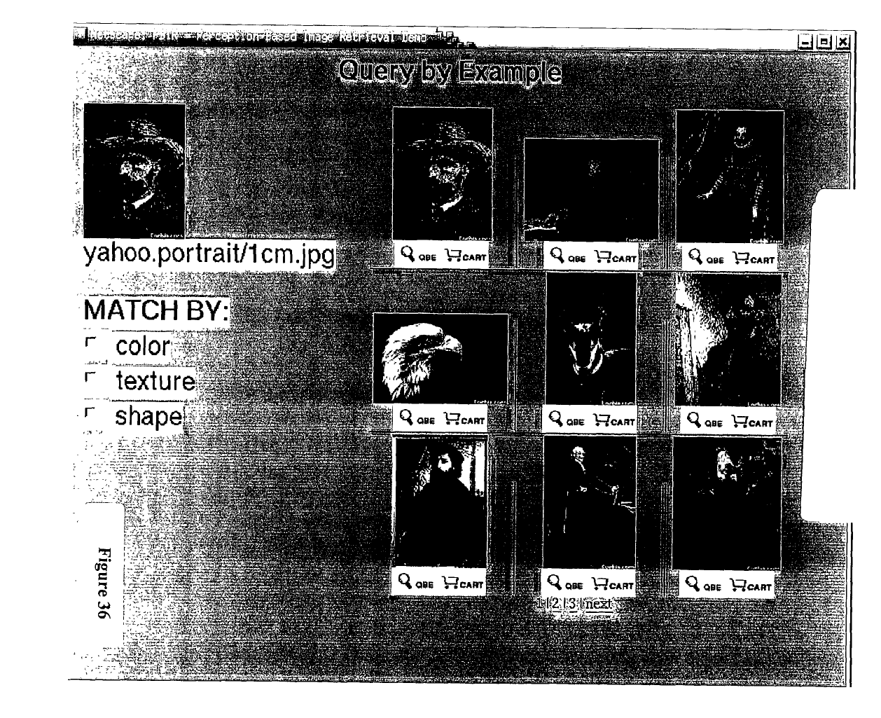

### [INSERT FIG. 36 HERE]

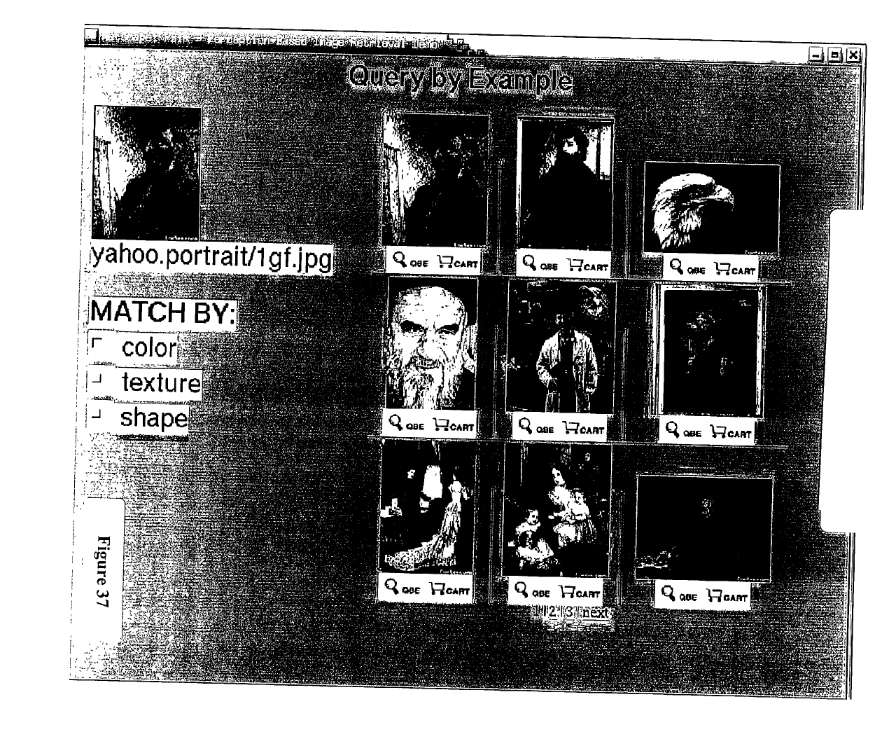

### [INSERT FIG. 37 HERE]

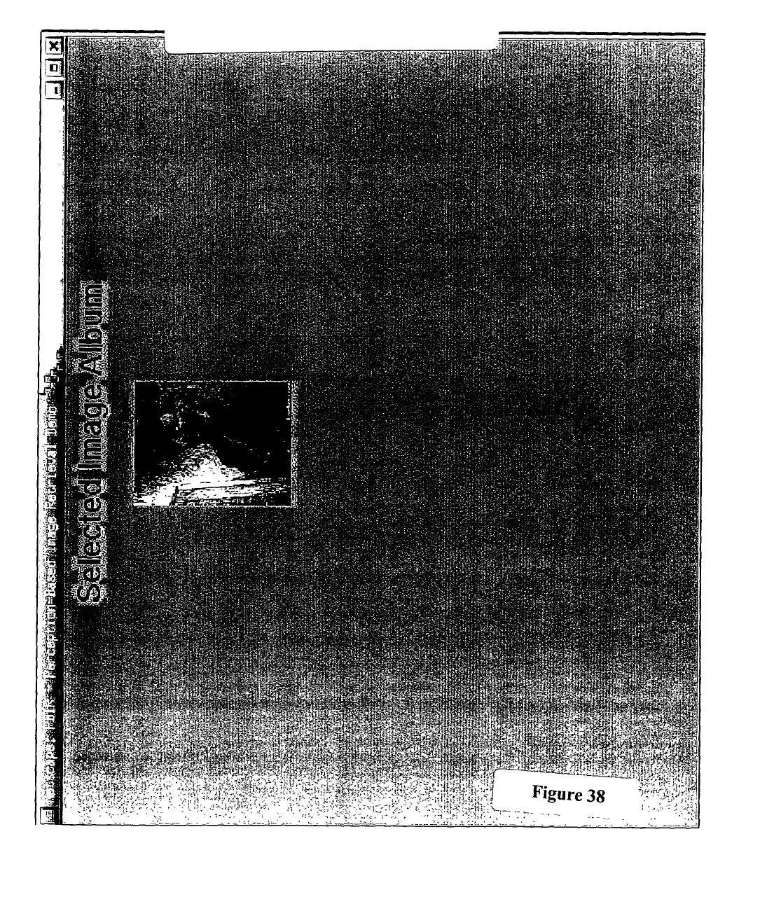

### [INSERT FIG. 38 HERE]

Screen 1. Initial Screen. The system presents the initial screen to the user as shown in FIG. 32. The screen is split into two frames horizontally. On the left-hand side of the screen is the learner frame; on the right-hand side is the search result frame. Through the learner frame, the system learns what the user wants via an active learning process. The search result frame displays images that match the user's query concept.

Screen 2. Sampling and relevance feedback starts. Once the user clicks the “submit” button in the initial frame, the active learning step commences to learn what the user wants. The system presents a number of samples in the learner frame, and the user marks images that are relevant to his or her query concept by clicking on the relevant images. As shown in FIG. 33, one image (the third image of the last row) are selected as relevant, and the rest of the unmarked images are considered irrelevant. The user indicates the end of his or her selection by clicking on the submit button in the learner screen. This action brings up the next screen.

Screen 3. Sampling and relevance feedback continues. FIG. 34 shows the third screen. First, the search result frame displays what the system thinks will match the user's query concept at this time. As the figure indicates, two returned images fit the concept of “Vincent van Gogh.” The user's query concept has been captured, though somewhat fuzzily. The user can ask the system to further refine the target concept by selecting relevant images in the learner frame. In this example, one image (the second image of the third row) are relevant to the concept. After the user clicks on the submit button in the learner frame, the fourth screen is displayed.

Screen 4. Sampling and relevance feedback ends. FIG. 35 shows that eight images fit the query concept (Vincent van Gogh).

2. Query by Example (QBE).

Screen 5. Query-by-example starts. At any time, the user can click on the QBE icon below each image on the search result screen to request images that appear similar to the selected image. This step allows the user to zoom into a specific set of images that match some appearance criteria, such as color distribution, textures, and shapes. For example, after we click the QBE icon below the third image of the first row on the right-hand side frame in FIG. 35, the system pops up a query-by-example window as shown in FIG. 36. Users can select their desired matching criteria by clicking on the check box shown on the query-by-example window. The default matching criteria are based on combinations of color distribution, textures, and shapes.

Screen 6. Change matching criteria. The user can choose their desired matching criteria by clicking on the corresponding check boxes. By clicking on the third image of the second row on the query-by-example window, FIG. 37 shows another query-by-example image retrieval using “color” as the matching criterion.

3. Image Collection.

Screen 7. Image collection. At any time, the user can click on the CART icon below each image on the search result screen to put the image into an album. In this way, the user can collect their favorite images in an album. For example, in FIG. 37, by clicking on the CART icon of the first image of the first row, the selected images are put in an album as shown in FIG. 38.

3. Example—User Interface as Front-end to MEGA

In the following, we present an interActive query session using MEGA. This interActive query session involves seven screens that are illustrated in seven figures. The user's query concept in this example is “wild animals.”

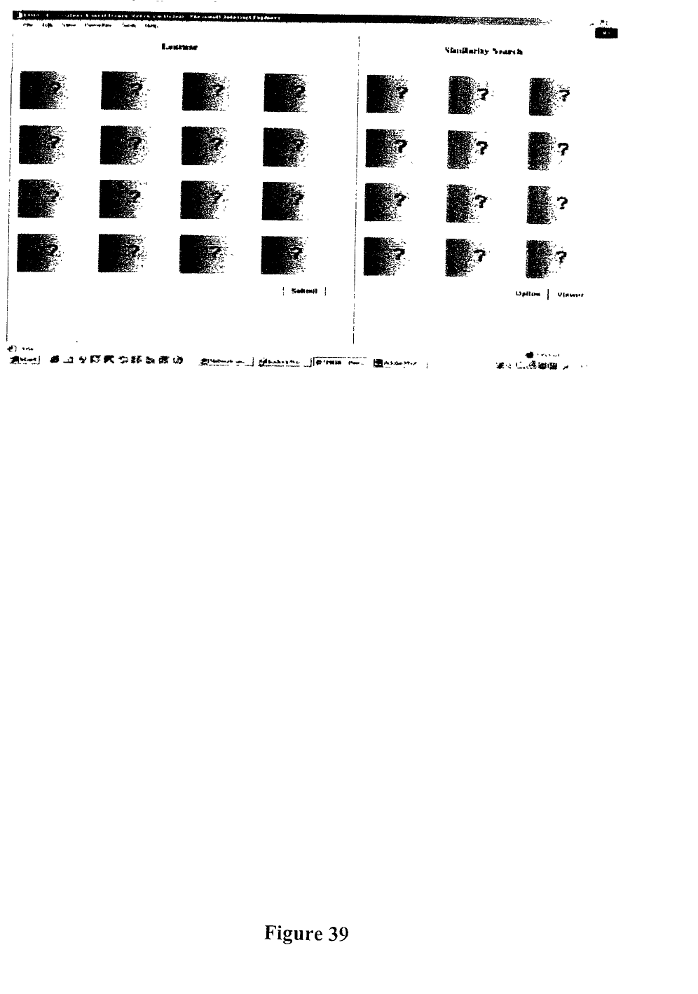

Screen 1. [FIG. 39] Initial Screen. Our PBIR system presents the initial screen to the user as depicted in FIG. 39. The screen is split into two frames vertically. On the left-hand side of the screen is the learner frame; on the right-hand side is the similarity search frame. Through the learner frame, PBIR learns what the user wants via an intelligent sampling process. The similarity search frame displays what the system thinks the user wants. (The user can set the number of images to be displayed in these frames.)

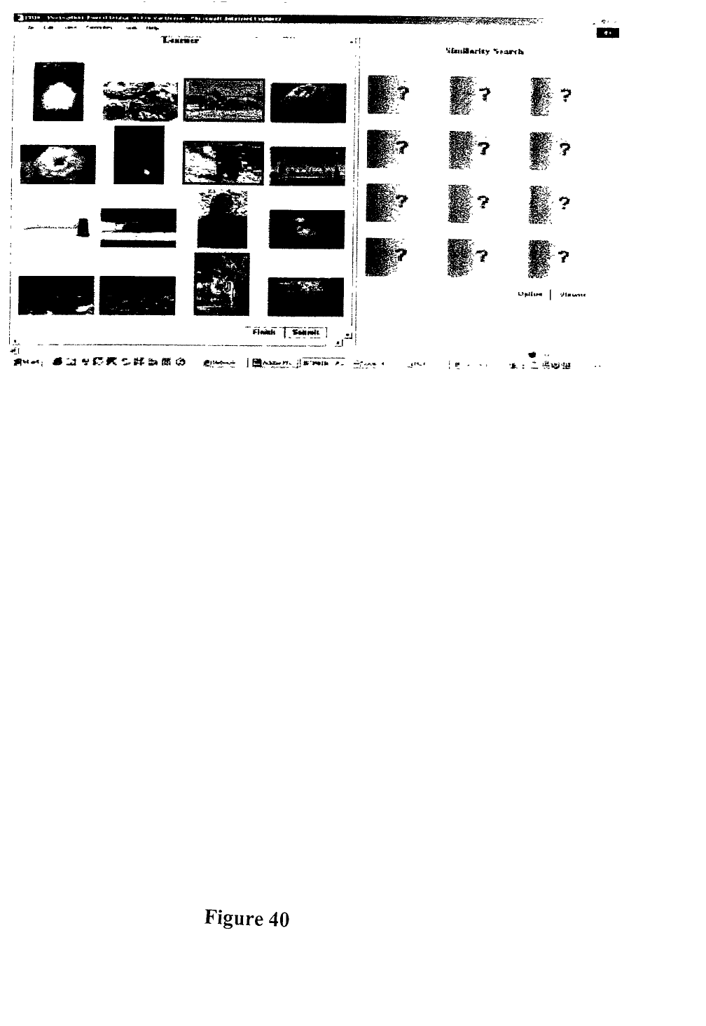

Screen 2. [FIG. 40] Sampling and relevance feedback starts. Once the user clicks the “submit” button in the initial frame, the sampling and relevance feedback step commences to learn what the user wants. The PBIR system presents a number of samples in the learner frame, and the user highlights images that are relevant to his/her query concept by clicking on the relevant images.

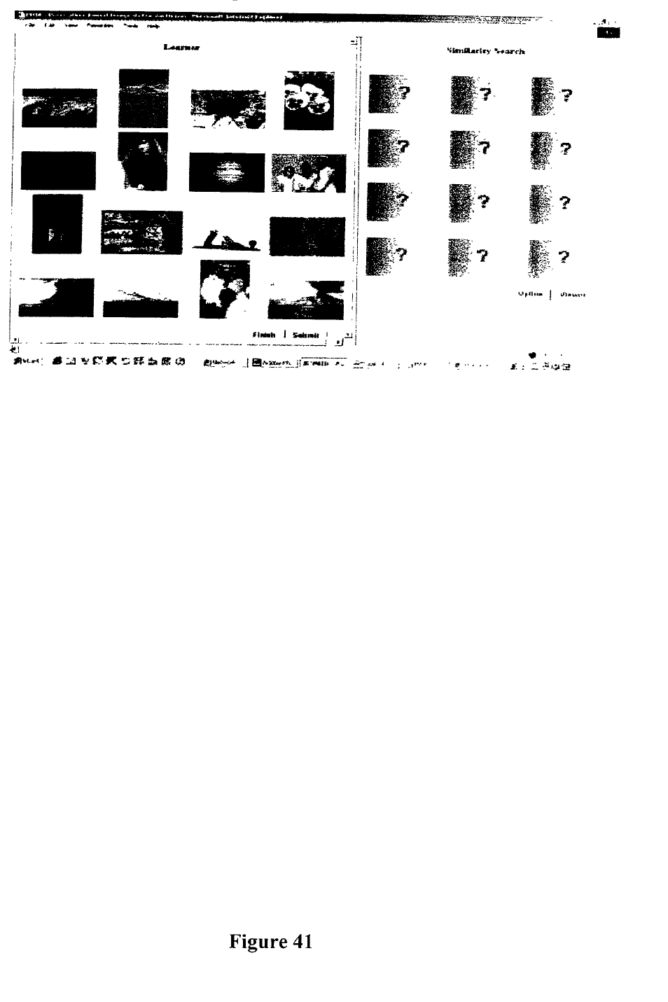

As shown in FIG. 41, three images (the third image in rows one, two and four in the learner frame) are selected as relevant, and the rest of the unmarked images are considered irrelevant. The user indicates the end of his/her selection by clicking on the submit button in the learner screen. This action brings up the next screen.

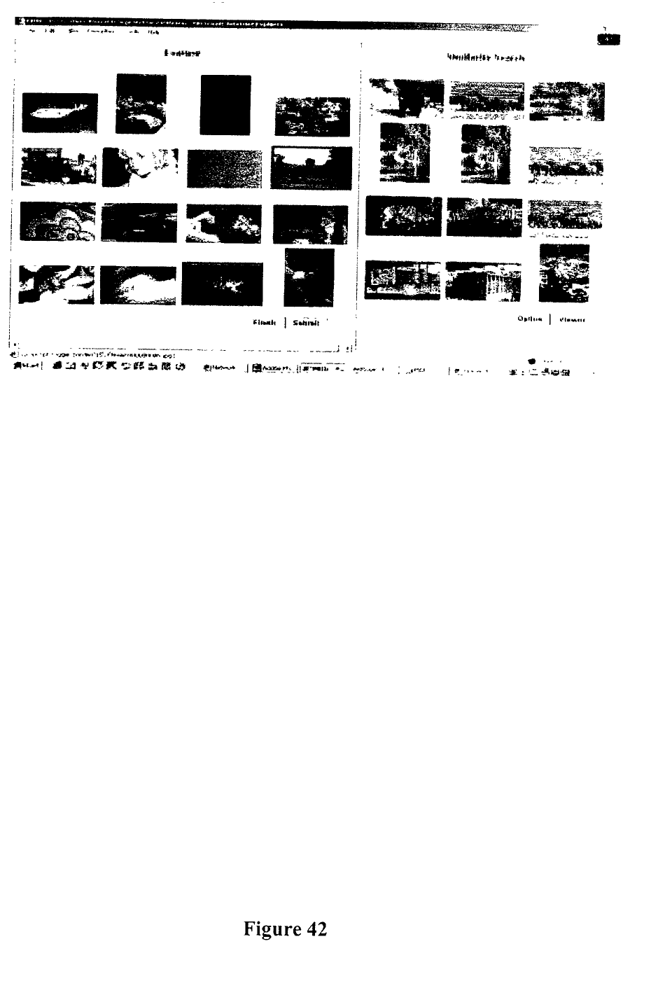

Screen 3. [FIG. 42] Sampling and relevance feedback continues. FIG. 42 shows the third screen. At this time, the similarity search frame still does not show any image, since the system has not been able to grasp the user's query concept at this point. The PBIR system again presents samples in the learner frame to solicit feedback. The user selects the second image in the third row as the only image relevant to the query concept.

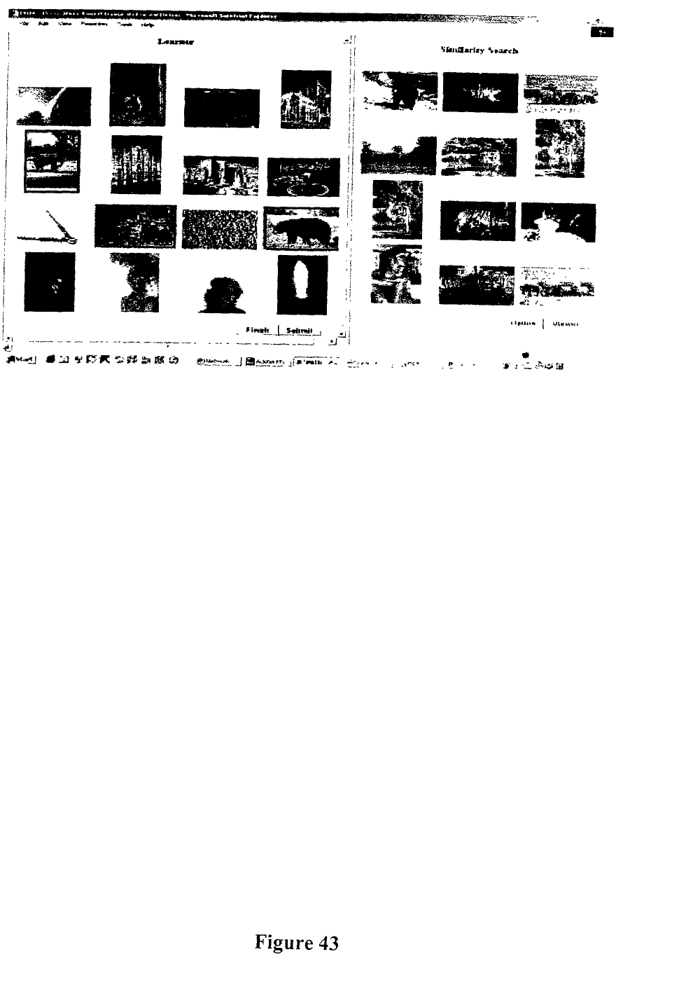

Screen 4. [FIG. 43] Sampling and relevance feedback continues. FIG. 43 shows the fourth screen. First, the similarity search frame displays what the PBIR system thinks will match the user's query concept at this time. As the figure indicates, the top nine returned images fit the concept of “wild animals.” The user's query concept has been captured, though somewhat fuzzily. The user can ask the system to further refine the target concept by selecting relevant images in the learner frame. In this example, the fourth image in the second row and the third image in the fourth row are selected as relevant to the concept. After the user clicks on the submit button in the learner frame, the fifth screen is displayed.

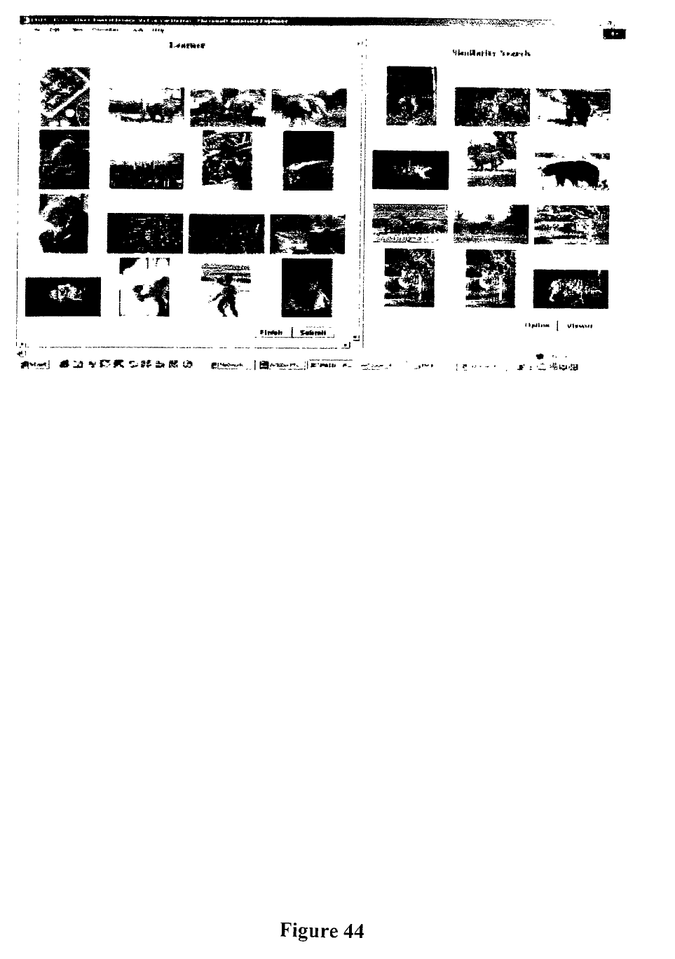

Screen 5. [FIG. 44] Sampling and relevance feedback continues. The similarity search frame in FIG. 44 shows that ten out of the top twelve images returned match the “wild animals” concept. The user selects four relevant images displayed in the learner frame. This leads to the final screen of this learning series.

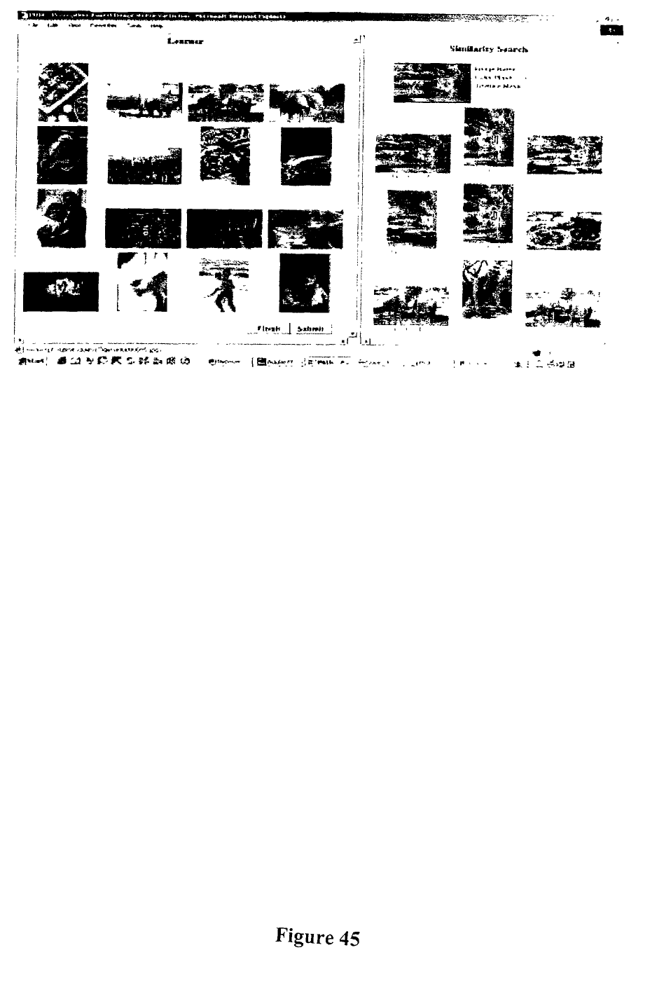

Screen 6. [FIG. 45] Sampling and relevance feedback ends. FIG. 45 shows that all returned images in the similarity search frames fit the query concept.

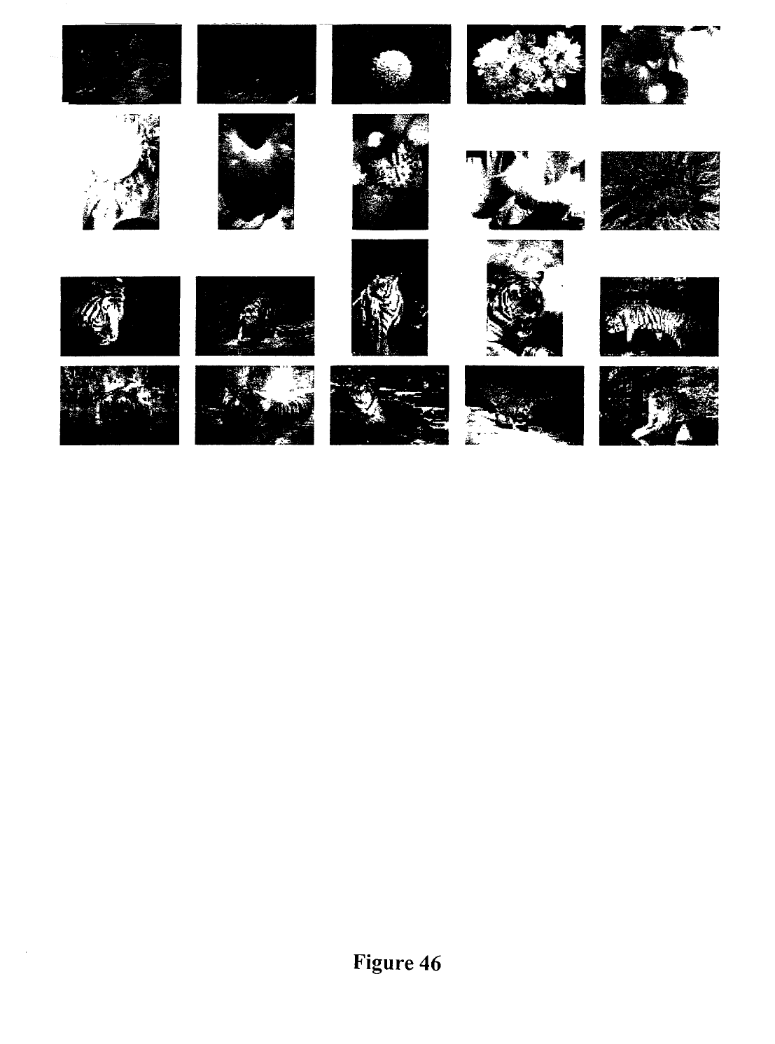

Screen 7. [FIG. 46] Similarity search. At any time, the user can click on an image in the similarity search frame to request images that appear similar to the selected image. This step allows the user to zoom in onto a specific set of images that match some appearance criteria, such as color distribution, textures and shapes. As shown in [FIG. 46], after clicking on one of the tiger images, the user will find similar tiger images returned in the similarity search frame. Notice that other wild animals are ranked lower than the matching tiger images, since the user has concentrated more on specific appearances than on general concepts.

In summary, in this example we show that our PBIR system effectively uses MEGA to learn a query concept. The images that match a concept do not have to appear similar in their low-level feature space. The learner is able to match high-level concepts to low-level features directly through an intelligent learning process. Our PBIR system can capture images that match a concept through MEGA, whereas the traditional image systems can do only appearance similarity searches. Again, as illustrated by this example, MEGA can capture the query concept of wild animal (wild animals can be elephants, tigers, bears, and etc), but a traditional similarity search engine can at best select only animals that appear similar.

### Samples Characterized By Maximum Uncertainty

The sample representations that appear on a sample screen display are characterized by maximum uncertainty as to whether a given user would consider a given individual sample to be relevant to that given user's query concept base upon that given user's prior indication of relevance of prior sample representations to that given user's query concept. In other words, in a preferred embodiment of the invention, each individual sample representation of a user concept that appears in a collection of samples displayed together on a sample screen is characterized by its level of uncertainty as to whether a user will select that sample as being relevant to his/her given query concept. Specifically, in a preferred embodiment each individual sample representation is characterized by maximum uncertainty as to whether or not the given user will indicate that sample to be relevant to that given user's query concept. As used herein, the term ‘maximum’ is a term that finds its meaning relative to the level of uncertainty associated with the body or database or universe of potential sample representations under consideration.

The words, ‘maximum uncertainty’ as used herein mean, among the greatest uncertainties relative to the uncertainties currently characterizing other sample representations. The term ‘maximum’ is not intended to connote a requirement of an absolute maximum possible uncertainty for every sample representation appearing in the sample display screen. Nor is it intended to require the appearance of only those sample representations characterized by the largest uncertainty, to the exclusion of all other sample representations characterized by relatively large uncertainties. Despite this intended range of meaning of the words ‘maximum uncertainty’, in a presently preferred embodiment of the invention, the sample representations having the largest uncertainties are the sample representations that appear in the sample screen display.

Sample representations characterized by maximum uncertainty can be identified in several ways. For example, possible techniques include: (1) MEGA; (2) Support Vector Machines; and (3) Bayesian Formulation. It will be appreciated that these approaches are provided in order to provide a person skilled in the art with an understanding of what is meant by ‘maximum uncertainty’. However, the present invention does not itself use these techniques. Rather, the present invention is limited to a user interface and related methods and article of manufacture to display sample representations and results representations identified as having maximum uncertainty using these techniques. In other words, it is techniques such as these that can be used to apply the ‘maximum uncertainty’ characterization to the displayed sample, representations.

### MEGA

The MEGA (Maximizing Expected Generalization Algorithm) technique of identification of sample representations having maximum uncertainty involves selecting sample representations that are at or near a prescribed distance from a query concept space. That prescribed distance can be arrived at using an algorithm that maximizes the expected generalization of the query concept. One example of such an algorithm is described in U.S. patent application, Ser. No.10/116,383, filed Apr. 2, 2002, which is expressly incorporated herein by this reference.

### Support Vector Machines

The support vector machines technique of identification of sample representations having maximum uncertainty involves selecting sample representations that appear at or near a hyperplane. The hyperplane is arrived at using a support vector machine algorithm. A support vector machine algorithm technique is described in, S. Tong and E. Chang, Support Vector Machine Active Learning for Image Retrieval, a copy of which is attached hereto as Exhibit A and is expressly incorporated herein in its entirety by this reference.

### BAYESIAN FORMULATION

The Bayesian formulation technique of identification of sample representations having maximum uncertainty involves selecting sample representations that are labeled as possessing at or near maximum uncertainty as to whether the given user would indicate such sample representations as being relevant to the user's concept. The labeling is arrived at using a Bayesian algorithm. The Bayesian formulation is described in I. Cox, M. Miller, T. Minka, T. Papathomas and P. Yianilos, The Bayesian Image Retrieval System, PicHunter: Theory, Implementation and Psychophysical Experiments, IEEE Transactions on Image Processing, Vol. XX, No. YY, MONTH, 2000, which is expressly incorporated herein by this reference.

The following quote is a small excerpt from that paper.

“During each iteration t=1, 2, . . . of a PicHunter session, the program displays a set Dₜ of N_{D} images from its data base, and the user takes an action Aₜ in response, which the program observes. For convenience the history of the session through iteration t is denoted Hₜ and consists of {D₁, A₁, D₂, A₂, . . . , Dₜ, Aₜ}.

The database images are denoted Tₗ, . . . , Tₙ, and PicHunter takes a probabilistic approach regarding each of them as a putative target.¹ After iteration t PicHunter's estimate of the probability that database image Tₗ is the user's target T, given the session history, is then written P(T=Tₗ|Hₜ). The system's estimate prior to starting the session is denoted P(T=Tₗ). After iteration t the program must select the next set Dₜ₊₁ of images to display. The canonical strategy for doing so selects the most likely images, but other possibilities are explored later in this paper. So long as it is deterministic, the particular approach taken is not relevant to our immediate objective of giving a Bayesian prescription for the computation of P(T=Tₗ|Hₜ). From Bayes' rule we have: ¹ This amounts to the implicit assumption that the target is in the database, and this is indeed the case in all of our experiments. Formulations without this assumption are possible but arc beyond the scope of this paper.

$$\begin{matrix}P ( T = {T}_{z} \vert {H}_{t} ) = \frac{P ( {H}_{t} \vert T = {T}_{z} ) P ( T = {T}_{z} )}{P ( {H}_{t} )} \\ = \frac{P ( {H}_{t} \vert T = {T}_{z} ) P ( T = {T}_{z} )}{{\sum }_{j = 1}^{n} P ( {H}_{t} \vert T = {T}_{j} ) P ( T = {T}_{j} )}\end{matrix}$$

That is, the a posteriori probability that image Tₗ is the target, given the observed history, may be computed by evaluating P(Hₜ|T=Tᵢ), which is the history's likelihood given that the target is, in fact, Tᵢ. Here P(T=Tₗ) represents the a priori probability. The canonical choice of P(T=Tᵢ) assigns probability 1/n to each image, but one might use other starting functions that digest the results of earlier sessions.² ² The starting function must not assign probability zero to any image, otherwise the system's (1 posterior estimate of its probability will always remain zero

The PicHunter system performs the computation of P(T=Tₗ) incrementally from P(T=Tₗ|Hₜ₋₁) according to:

$$\begin{matrix}P ( T = {T}_{z} \vert {H}_{t} ) = P ( T = {T}_{z} \vert {D}_{t} , {A}_{t} , {H}_{t - 1} ) = \frac{P ( {D}_{t} , {A}_{t} \vert T = {T}_{z} , {H}_{t - 1} ) P ( {D}_{t} , T = {T}_{z} \vert {H}_{t - 1} )}{{\sum }_{j = 1}^{n} P ( {D}_{t} , {A}_{t} \vert T = {T}_{j} , {H}_{t - 1} ) P ( T = {T}_{j} \vert {H}_{t - 1} )} \\ = \frac{P ( {A}_{t} \vert T = {T}_{z} , {D}_{t} , {H}_{t - 1} ) P ( T = {T}_{z} \vert {H}_{t - 1} )}{{\sum }_{j = 1}^{n} P ( {A}_{t} \vert T = {T}_{j} , {D}_{t} , {H}_{t - 1} ) P ( T = {T}_{j} \vert {H}_{t - 1} )}\end{matrix}$$

where we may write P(Aₜ|T=Tₗ, Dₜ, Hₜ₋₁) instead of P(Dₜ, Aₜ|T=Tᵢ, Hₜ₋₁) because Dₜ is a deterministic function of Hₜ₋₁.

The heart of our Bayesian approach is the term P(Aₜ|T=Tₗ, Dₜ, Hₜ₋₁), which we refer to as the user model because its goal is to predict what the user will do given the entire history Dₜ, Hₜ₋₁, and the assumption that Tₗ is his/her target. The user model together with the prior give rise inductively to a probability distribution on the entire event space T×Ht, where T denotes the database of images and Ht denotes the set of all possible history sequences Dₗ, Aₗ, . . . , Dₗ, Aₗ.”

Thus, a Bayesian formulation technique can involve re-labeling, and thereby re-characterizing, each possible sample representation in a prescribed universe of possible sample representations with a new probability or uncertainty after each indication by a given user of the relevance of a prior set of sample representations to the given user's query concept.

### Feature Space

Each sample image is characterized by a set of features. Individual features are represented by individual terms of an expression that represents the image. The individual terms are calculated based upon constituent components of an image. For instance, in a present embodiment of the invention, the pixel values that comprise an image are processed to derive values for the features that characterize the image. For each image there is an expression comprising a plurality of feature values. Each value represents a feature of the image. In a present embodiment, each feature is represented by a value between 0 and 1. Thus, each image corresponds to an expression comprising terms that represent features of the image.

The following Color Features Table and Texture Features Table represent the features that are evaluated for images in accordance with a present embodiment of the invention. The image is evaluated with respect to 11 recognized cultural colors (black, white, red, yellow, green, blue, brown, purple, pink, orange and gray) plus one miscellaneous color for a total of 12 colors. The image also is evaluated for vertical, diagonal and horizontal texture. Each image is evaluated for each of the twelve (12) colors, and each color is characterized by the nine (9) color features listed in the Color Table. Thus, one hundred and eight (108) color features are evaluated for each image. In addition, each image is evaluated for each of the thirty-six (36) texture features listed in the Texture Chart. Therefore, one hundred and forty-four (144) features are evaluated for each image, and each image is represented by its own 144 (feature) term expression.

TABLE 5
Color Features

Present %
Hue — average
Hue — variance
Saturation — average
Saturation — variance
Intensity — average
Intensity — variance
Elongation
Spreadness

TABLE 6
Texture Features

| | Coarse | Medium | Fine |
|---|---|---|---|
| Horizontal | Avg. Energy | Avg. Energy | Avg. Energy |
| | Energy Variance | Energy Variance | Energy Variance |
| | Elongation | Elongation | Elongation |
| | Spreadness | Spreadness | Spreadness |
| Diagonal | Avg. Energy | Avg. Energy | Avg. Energy |
| | Energy Variance | Energy Variance | Energy Variance |
| | Elongation | Elongation | Elongation |
| | Spreadness | Spreadness | Spreadness |
| Vertical | Avg. Energy | Avg. Energy | Avg. Energy |
| | Energy Variance | Energy Variance | Energy Variance |
| | Elongation | Elongation | Elongation |
| | Spreadness | Spreadness | Spreadness |

The computation of values for the image features such as those described above is well known to persons skilled in the art.

Color set, histograms and texture feature extraction are described in John R. Smith and Shih-Fu Chang, Tools and Techniques for Color Image Retrieval, IS&T/SPIE Proceedings, Vol. 2670, Storage & Retrieval for Image and Video Database IV, 1996, which is expressly incorporated herein by this reference.

Color set and histograms as well as elongation and spreadness are described in E. Chang, B. Li, and C. L. Towards Perception-Based Image Retrieval. IEEE, Content-Based Access of Image and Video Libraries, pages 101-105, June 2000, which is expressly incorporated herein by this reference.

The computation of color moments is described in Jan Flusser and Tomas Suk, On the Calculation of Image Moments, Research Report No. 1946, January 1999, Journal of Pattern Recognition Letters, which is expressly incorporated herein by this reference. Color moments are used to compute elongation and spreadness.

There are multiple resolutions of color features. The presence/absence of each color is at the coarse level of resolution. For instance, coarsest level color evaluation determines whether or not the color red is present in the image. This determination can be made through the evaluation of a color histogram of the entire image. If the color red constitutes less than some prescribed percentage of the overall color in the image, then the color red may be determined to be absent from the image. The average and variance of hue, saturation and intensity (HVS) are at a middle level of color resolution. Thus, for example, if the color red is determined to be present in the image, then a determination is made of the average and variance for each of the red hue, red saturation and red intensity. The color elongation and spreadness are at the finest level of color resolution. Color elongation can be characterized by multiple (7) image moments. Spreadness is a measure of the spatial variance of a color over the image.

There are also multiple levels of resolution for texture features. Referring to the Texture Table, there is an evaluation of the coarse, middle and fine level of feature resolution for each of vertical, diagonal and horizontal textures. In other words, an evaluation is made for each of the thirty-six (36) entries in the Texture Features Table. Thus, for example, referring to the horizontal-coarse (upper left) block in the Texture Features Table, an image is evaluated to determine feature values for an average coarse-horizontal energy feature, a coarse-horizontal energy variance feature, coarse-horizontal elongation feature and a coarse-horizontal spreadness feature. Similarly, for example, referring to the medium-diagonal (center) block in the Texture Features Table, an image is evaluated to determine feature values for an average medium-diagonal energy feature, a medium-diagonal energy variance feature, medium-diagonal elongation feature and a medium-diagonal spreadness feature.

### ‘Well Separated’ Samples

In a present embodiment of the invention, the sample representations (e.g., sample images in a current embodiment) not only are characterized by ‘maximum uncertainty’ as to whether given user would consider them to be relevant to the given user's query concept, but also are ‘well separated’ in a feature space. The reason for wanting samples that are ‘well separate’ is to avoid, to the extent reasonably possible, sample representation that are redundant with respect to each other. In a present embodiment, the features space comprises image features including color, texture and shape. It will be appreciated that the shape features are inextricably tied to color and texture, since shape in an image is determined, for example, from the spreadness or elongation or orientation (vertical, horizontal diagonal) of color regions or texture of an image.

In a current embodiment, clustering is used to ensure that the sample representations in a set of sample representation presented to a user in a screen display are ‘well separated’ in feature space. Basically, sample representations (e.g., images) in a database of sample representations are clustered based on their features. Sample representations having features that are similar (as determined by a clustering algorithm—which forms no part of the present invention or the user interface) are clustered together. Clustering ensures that the sample representations in any given cluster are ‘well separated’ in feature space from the sample representations in other clusters. Hence, by selecting sample representations which are not only characterized by ‘maximum uncertainty’, but also are selected from different clusters a set of sample representations are present to a user that can elicit maximum information about the user's query concept.

Clustering of samples: Presenting to a user multiple samples that are too similar to one another generally is not a particularly useful approach to identifying a query concept since such multiple samples may be redundant in that they elicit essentially the same information. Therefore, the query-concept learner process often attempts to select samples from among different clusters of samples in order to ensure that the selected samples in any given sample set presented to the user arc sufficiently different from each other. In a current embodiment, samples are clustered according to the feature sets manifested in their corresponding expressions. There are numerous processes whereby the samples can be clustered in a multi-dimensional sample space. For instance, U.S. Provisional Patent Application, Serial No. 60/324,766, filed Sep. 24, 2001, entitled, Discovery Of A Perceptual Distance Function For Measuring Similarity, invented by Edward Y. Chang, which is expressly incorporated herein by this reference, describes clustering techniques. For example, samples may be clustered so as to be close to other samples with similar feature sets and so as to be distant from other samples with dissimilar feature sets. Clustering is particularly advantageous when there is a very large database of samples to choose from. It will be appreciated, however, that there may be situations in which it is beneficial to present to a user samples which are quite similar, especially when the k-CNF already has been significantly refined through user feedback.

### Interplay Between Learner Frame and Similarity Search Frame

A role of the learner frame is to present to a user with sets of sample representations (e.g., images) that will elicit the maximum information from the user about the user's query concept. In order to achieve this end, the sample representations that are presented are characterized by ‘maximum uncertainty’ and are ‘well separated’ from each other in feature space. Samples that have maximum uncertainty can glean maximum information as to the user's query concept. Samples characterized by the maximum uncertainty represent current areas of greatest uncertainty about the user's query concept. Therefore, gleaning information from the user as to the relevance of these most uncertain samples is likely to provide the greatest insight or learning or information about the user's query concept. As a user progresses form one learner frame to the next, the learner frame samples do not necessarily tend to converge on the user's query concept. Rather, behind-the-scenes algorithms such as MEGA, SVM or Bayesian continually attempt to compose a new sets of sample representations comprising samples that are characterized by maximum uncertainty based on the evolving understanding of the user's query concept, and that are well separated form each other in sample space. Both positive and negative labeled samples can be used to ascertain a user's query concept. If the user indicates that a sample is relevant. then it can be inferred that the sample is in fact relevant If the user fails to mark a sample as relevant then it can be inferred that the unmarked sample in fact is not relevant to the user's query concept.

A role of the similarity search frame is to provide the user with an immediate indication of the progress of the query concept search and to also give the user an opportunity to immediately zero in on search results that closely match the user's query concept. The similarity search frame presents results (e.g., images) that most closely match the samples indicated by the user to match the query concept. Thus, as the learner frame guides the user through an inquiry that continually asks the user to respond to samples that have maximum uncertainty as to the query concept, the similarity search frame provides search results that ideally do converge on the user's query concept.

Various modifications to the preferred embodiments can be made without departing from the spirit and scope of the invention. Thus, the foregoing description is not intended to limit the invention which is described in the appended claims.

[image]

[image]

[image]

[image]

[image]

[image]

[image]

[image]

[image]

[image]

[image]

[image]

1. A computer user interface screen comprising:
a set of multiple possible sample representations of a user query concept in which individual samples of the set of query samples are characterized by a maximum uncertainty as to whether a given user would consider a given individual sample representation to be relevant to that given user's query concept based upon that given user's prior indications of relevance of prior sample representations to that given user's query concept.

2. The computer user interface screen of claim 1 wherein,
the given user's prior indications of relevance of prior sample representations to that given user's query concept include both positive and negative indications of relevance.

3. The computer user interface screen of claim 1 wherein,
the given user's prior indications of relevance of prior sample representations to that given user's query concept include both positive and negative indications of relevance; and
only the user's positive indications of relevance are explicit.

4. The computer user interface screen of claim 1 wherein,
the given user's prior indications of relevance of prior sample representations to that given user's query concept include both positive and negative indications of relevance; and
only the user's negative indications of relevance are explicit.

5. The computer user interface screen of claim 1 further including:
a mechanism to receive a user indication of relevance of one or more sample representations to the user's query concept.

6. The computer user interface screen of claim 1 further including:
a set of one or more results representations characterized by similarity to the given user's query concept based upon the given user's indications of relevance of prior sample representations to that given user's query concept.

7. The computer user interface screen of claim 1 further including:
a set of K results representations characterized by similarity to the given user's query concept based upon the given user's indications of relevance of prior sample representations to that given user's query concept;
wherein K is a user-selectable value; and
wherein the set of K results representations includes the top K most similar representations with respect to the user's query concept based upon the user's indications of relevance of prior sample representations to that given user's query concept.

8. The computer user interface screen of claim 6 or 7 wherein,
the given user's prior indications of relevance of prior sample representations to that given user's query concept include both positive and negative indications of relevance.

9. The computer user interface screen of claim 6 or 7 wherein,
the given user's prior indications of relevance of prior sample representations to that given user's query concept include both positive and negative indications of relevance; and
only the user's positive indications of relevance are explicit.

10. The computer user interface screen of claim 6 or 7 wherein,
the given user's prior indications of relevance of prior sample representations to that given user's query concept include both positive and negative indications of relevance; and
only the user's negative indications of relevance are explicit.

11. The computer user interface screen of claim 1 wherein,
respective individual samples of the set of multiple possible query sample representations are respectively characterized by a plurality of features from a feature space; and
respective the samples of the set of multiple possible query sample representations are well separated from each other in the feature space.

12. The computer user interface screen of claim 11 wherein,
the feature space includes a range of color features and a range of texture features.

13. The computer user interface screen of claim 11 wherein,
the feature space includes a range of color features and a range of texture features and a range of shape features.

14. The computer user interface screen of claim 1 wherein,
the maximum uncertainty characterizing the individual sample representation is achieved by composing the set of multiple possible query sample representations with sample representations that are at or near a prescribed distance from a query concept space;
wherein the prescribed distance is arrived at arrived at using an algorithm that maximizes the expected generalization of a query concept.

15. The computer user interface screen of claim 1 wherein,
the maximum uncertainty characterizing the individual sample representation is achieved by composing the set of multiple possible query sample representations with sample representations that are near a hyperplane;
wherein the hyperplane is arrived at using a support vector machine algorithm.

16. The computer user interface screen of claim 1 wherein,
the maximum uncertainty characterizing the individual sample representation is achieved by composing the set of multiple possible query sample representations with sample representations that are labeled as possessing at or near maximum uncertainty as to whether the given user would indicate such sample representations as being relevant to the user's query concept;
wherein the labeling is arrived at using a Bayesian algorithm.

17. A computer user interface comprising:
a set of multiple sample objects in which individual sample objects are characterized by a maximum uncertainty as to whether a given user would consider a given individual sample object to be relevant to that given user's query concept based upon that given user's indications of relevance of prior sample objects to that given user's query concept.

18. The computer user interface of claim 17 further including:
a mechanism to receive a user indication of relevance of one or more sample objects to the user's query concept.

19. The computer user interface of claim 17 further including:
a set of one or more results objects characterized by similarity to the given user's query concept based upon the given user's indications of relevance of sample objects to that given user's query concept.

20. The computer user interface of claim 17 wherein,
the given user's prior indications of relevance of prior sample objects to that given user's query concept include both positive and negative indications of relevance; and
only the user's negative indications of relevance are explicit.

21. The computer user interface of claim 17 further including:
a mechanism to receive a user indication of relevance of one or more sample objects to the user's query concept.

22. The computer user interface of claim 17 further including:
a set of one or more results objects characterized by similarity to the given user's query concept based upon the given user's indications of relevance of prior sample objects to that given user's query concept.

23. The computer user interface of claim 17 further including:
a set of K results objects characterized by similarity to the given user's query concept based upon the given user's indications of relevance of prior sample objects to that given user's query concept;
wherein K is a user-selectable value; and
wherein the set of K results objects includes the top K most similar objects with respect to the user's query concept based upon the user's indications of relevance of prior sample objects to that given user's query concept.

24. The computer user interface of claim 22 or 23 wherein,
the given user's prior indications of relevance of prior sample objects to that given user's query concept include both positive and negative indications of relevance.

25. The computer user interface of claim 22 or 23 wherein,
the given user's prior indications of relevance of prior sample objects to that given user's query concept include both positive and negative indications of relevance; and
only the user's positive indications of relevance are explicit.

26. The computer user interface of claim 22 or 23 wherein,
the given user's prior indications of relevance of prior sample objects to that given user's query concept include both positive and negative indications of relevance; and
only the user's negative indications of relevance are explicit.

27. The computer user interface of claim 17 wherein,
respective individual samples of the set of multiple possible query sample objects are respectively characterized by a plurality of features from a feature space; and
respective the sample objects of the set of multiple possible query sample objects are well separated from each other in the feature space.

28. The computer user interface of claim 27 wherein,
the feature space includes a range of color features and a range of texture features.

29. The computer user interface of claim 27 wherein,
the feature space includes a range of color features and a range of texture features and a range of shape features.

30. The computer user interface of claim 17 wherein,
the maximum uncertainty characterizing the individual sample objects is achieved by composing the set of multiple sample objects with sample objects that are at or near a prescribed distance from a query concept space;
wherein the prescribed distance is arrived at arrived at using an algorithm that maximizes the expected generalization of a query concept.

31. The computer user interface of claim 17 wherein,
the maximum uncertainty characterizing the individual sample objects is achieved by composing the set of multiple sample objects with sample objects that are near a hyperplane;
wherein the hyperplane is arrived at using a support vector machine algorithm.

32. The computer user interface screen of claim 17 wherein,
the maximum uncertainty characterizing the individual sample objects is achieved by composing the set of multiple sample objects with sample objects that are labeled as possessing at or near maximum uncertainty as to whether the given user would indicate such sample representations as being relevant to the user's query concept;
wherein the labeling is arrived at using a Bayesian algorithm.

33. A computer user interface screen system comprising:
a first sample screen displaying a first set of multiple possible query sample representations of a user query concept in which individual samples of the first set of query samples are characterized by maximum uncertainty as to whether a given user would consider a given individual sample representation of the first set to be relevant to that given user's query; and
a second sample screen presented after the first sample screen and displaying a second set of multiple possible query sample representations of a user query concept in which individual samples of the second set of query samples are characterized by maximum uncertainty as to whether a given user would consider a given individual sample representation of the second set to be relevant to that given user's query concept based upon that given user's indications of relevance of sample representations from the first set of query sample representations to that given user's query concept; and
a mechanism to receive a user indication of relevance of one or more sample representations from each of the sets of multiple possible sets of sample representations to the given user's query concept.

34. The computer user interface screen system of claim 33 further including:
a third sample screen presented after the second sample screen and displaying a third set of multiple possible query sample representations of a user query concept in which individual samples of the third set of query samples are characterized by maximum uncertainty as to whether a given user would consider a given individual sample representation of the third set to be relevant to that given user's query concept based upon that given user's indications of relevance of sample representations from the first and second sets of query sample representations to that given user's query concept.

35. The computer user interface screen system of claim 34 further including:
a third sample screen presented after the second sample screen and displaying a third set of multiple possible query sample representations of a user query concept in which individual samples of the third set of query samples are characterized by maximum uncertainty as to whether a given user would consider a given individual sample representation of the third set to be relevant to that given user's query concept based upon that given user's indications of relevance of sample representations from the first and second sets of query sample representations to that given user's query concept; and
a fourth sample screen presented after the third sample screen and displaying a fourth set of multiple possible query sample representations of a user query concept in which individual samples of the fourth set of query samples are characterized by significant uncertainty as to whether a given user would consider a given individual sample representation of the fourth set to be relevant to that given user's query concept based upon that given user's indications of relevance of sample representations from the first, second and third sets of query sample representations to that given user's query concept.

36. The computer user interface screen system of claim 33 wherein,
the maximum uncertainty characterizing individual sample representations of the second set is achieved by composing the set of multiple possible query sample representations with sample representations that are at or near a prescribed distance from a query concept space;
wherein the prescribed distance is arrived at arrived at using an algorithm that maximizes the expected generalization of a query concept based upon the given user's indications of relevance to the given user's query concept of the sample representations of the first set.

37. The computer user interface screen system of claim 34 wherein,
the maximum uncertainty characterizing individual sample representations of the third set is achieved by composing the set of multiple possible query sample representations with sample representations that are at or near a prescribed distance from a query concept space;
wherein the prescribed distance is arrived at arrived at using an algorithm that maximizes the expected generalization of a query concept based upon the given user's indications of relevance to the given user's query concept of the sample representations of the first and second sets.

38. The computer user interface screen system of claim 35 wherein,
the maximum uncertainty characterizing individual sample representations of the fourth set is achieved by composing the set of multiple possible query sample representations with sample representations that are at or near a prescribed distance from a query concept space;
wherein the prescribed distance is arrived at arrived at using an algorithm that maximizes the expected generalization of a query concept based upon the given user's indications of relevance to the given user's query concept of the sample representations of the first, second and third sets.

39. The computer user interface screen system of claim 33 wherein,
the maximum uncertainty characterizing individual sample representations of the second set achieved by composing the set of multiple possible query sample representations with sample representations that are near a hyperplane;
wherein the hyperplane is arrived at using a support vector machine algorithm based upon the given user's indications of relevance to the given user's query concept of the sample representations of the first set.

40. The computer user interface screen system of claim 34 wherein,
the maximum uncertainty characterizing individual sample representations of the third set achieved by composing the set of multiple possible query sample representations with sample representations that are near a hyperplane;
wherein the hyperplane is arrived at using a support vector machine algorithm based upon the given user's indications of relevance to the given user's query concept of the sample representations of the first and second sets.

41. The computer user interface screen system of claim 35 wherein,
the maximum uncertainty characterizing individual sample representations of the fourth set achieved by composing the set of multiple possible query sample representations with sample representations that are near a hyperplane;
wherein the hyperplane is arrived at using a support vector machine algorithm based upon the given user's indications of relevance to the given user's query concept of the sample representations of the first, second and third sets.

42. The computer user interface screen system of claim 33 wherein,
the maximum uncertainty characterizing individual sample representations of the second set is achieved by composing the set of multiple possible query sample representations with sample representations that are labeled as possessing at or near maximum uncertainty as to whether the given user would indicate such sample representations as being relevant to the user's query concept;
wherein the labeling is arrived at using a Bayesian algorithm based upon the given user's indications of relevance to the given user's query concept of the sample representations of the first set.

43. The computer user interface screen system of claim 34 wherein,
the maximum uncertainty characterizing individual sample representations of the third set is achieved by composing the set of multiple possible query sample representations with sample representations that are labeled as possessing at or near maximum uncertainty as to whether the given user would indicate such sample representations as being relevant to the user's query concept;
wherein the labeling is arrived at using a Bayesian algorithm based upon the given user's indications of relevance to the given user's query concept of the sample representations of the first and second sets.

44. The computer user interface screen system of claim 35 wherein,
the maximum uncertainty characterizing individual sample representations of the fourth set is achieved by composing the set of multiple possible query sample representations with sample representations that are labeled as possessing at or near maximum uncertainty as to whether the given user would indicate such sample representations as being relevant to the user's query concept;
wherein the labeling is arrived at using a Bayesian algorithm based upon the given user's indications of relevance to the given user's query concept of the sample representations of the first, second and third sets.

45. The computer user interface screen system of claim 33 further including:
a first results screen presented together with the second sample screen and displaying a first set of one or more results representations characterized by similarity to the given user's query concept based upon the given user's indications of relevance of prior sample representations to that given user's query concept.

46. The computer user interface screen system of claim 45 further including:
a second results screen presented together with the third sample screen and displaying a second set of one or more results representations characterized by similarity to the given user's query concept based upon the given user's indications of relevance of prior sample representations to that given user's query concept.

47. The computer user interface screen system of claim 46 further including:
a third results screen presented together with the fourth sample screen and displaying a third set of one or more results representations characterized by similarity to the given user's query concept based upon the given user's indications of relevance of prior sample representations to that given user's query concept.

48. The computer user interface screen system of claim 33 further including:
a screen mechanism to receive a user indication of relevance of one or more sample representations to the user's query concept.

49. The computer user interface screen system of claim 45 wherein
the first results screen is associated with a query by example screen input to receive a user indication of desire receive one or more results representations that are similar to one or more user-indicated results representations displayed by the first results screen.

50. The computer user interface screen system of claim 45 wherein
the first results screen is associated with a query by example screen input to receive a user indication of desire receive one or more results representations that are similar to one or more user-indicated results representations displayed by the first results screen; and
the query by example screen input includes feature input to receive a user indication as to one or more features of the one or more additional sample representations are to match corresponding features of the at least one current sample representation.

51. The computer user interface screen system of claim 46 wherein
the second results screen is associated with a query by example screen input to receive a user indication of desire receive one or more results representations that are similar to one or more user-indicated results representations displayed by the second results screen.

52. The computer user interface screen system of claim 46 wherein
the second results screen is associated with a query by example screen input to receive a user indication of desire receive one or more results representations that are similar to one or more user-indicated results representations displayed by the second results screen; and
the query by example screen input includes feature input to receive a user indication as to one or more features of the one or more additional sample representations are to match corresponding features of the at least one current sample representation.

53. The computer user interface screen system of claim 47 wherein
the third results screen is associated with a query by example screen input to receive a user indication of desire receive one or more results representations that are similar to one or more user-indicated results representations displayed by the third results screen.

54. The computer user interface screen system of claim 47 wherein,
the third results screen is associated with a query by example screen input to receive a user indication of desire receive one or more results representations that are similar to one or more user-indicated results representations displayed by the third results screen; and
the query by example screen input includes feature input to receive a user indication as to one or more features of the one or more additional sample representations are to match corresponding features of the at least one current sample representation.

55. The computer user interface screen system of claim 33 wherein,
respective individual sample representations of the first and second sets of multiple possible query sample representations are respectively characterized by a plurality of features from a feature space; and
respective the samples of the first set of multiple possible query sample representations are well separated from each other in the feature space; and
respective the samples of the second set of multiple possible query sample representations are well separated from each other in the feature space.

56. The computer user interface screen system of claim 34 wherein,
respective individual sample representations of the first, second and third sets of multiple possible query sample representations are respectively characterized by a plurality of features from a feature space; and
respective the samples of the first set of multiple possible query sample representations are well separated from each other in the feature space;
respective the samples of the second set of multiple possible query sample representations are well separated from each other in the feature space; and
respective the samples of the third set of multiple possible query sample representations are well separated from each other in the feature space.

57. The computer user interface screen system of claim 35 wherein,
respective individual sample representations of the first, second, third and fourth sets of multiple possible query sample representations are respectively characterized by a plurality of features from a feature space; and
respective the samples of the first set of multiple possible query sample representations are well separated from each other in the feature space;
respective the samples of the second set of multiple possible query sample representations are well separated from each other in the feature space;
respective the samples of the third set of multiple possible query sample representations are well separated from each other in the feature space; and
respective the samples of the fourth set of multiple possible query sample representations are well separated from each other in the feature space.

58. The computer user interface screen system of claim 35 wherein,
the feature space includes color, texture and shape.

59. A computer readable storage medium encoded with a computer program that functions to produce the computer user interface screen of claim 1 or 6.

60. A computer readable storage medium encoded with a computer program that functions to produce the computer user interface screen of claim 33, 34, 35, 45, 46, 47, 49, 51, 53, 55, 56 or 59.
